(19) United States
(12) Patent Application Publication
(10) Pub. No.: US 2019/0312240 A1
(43) Pub. Date: Oct. 10, 2019

(54) BATTERY PACK

(71) Applicant: MURATA MANUFACTURING CO., LTD., Kyoto (JP)

(72) Inventor: Yuta NIKAIDO, Kyoto (JP)

(21) Appl. No.: 16/434,741

(22) Filed: Jun. 7, 2019

Related U.S. Application Data
(63) Continuation of application No. PCT/JP2017/037325, filed on Oct. 16, 2017.

(30) Foreign Application Priority Data
Dec. 9, 2016 (JP) 2016-239919

(51) Int. Cl. H01M 2/10; H01M 2/26

(52) U.S. Cl. CPC H01M 2/1016; H01M 2/26

(57) ABSTRACT

Provided is a battery pack which has excellent battery characteristics and excellent reliability. The battery pack includes at least a battery cell and a holder, where the battery cell is configured to be accommodated in the holder, the holder includes a plate-shaped member having a first placement surface with the battery cell placed thereon, and a first side surface member and a second side surface member that are substantially perpendicular to the first placement surface and extend to the side with the battery cell, where the first side surface member and the second side surface member are larger in length extending to the side with the battery cell than the battery cell in a direction substantially perpendicular to the first placement surface.

### CROSS REFERENCE TO RELATED APPLICATIONS

The present application is a continuation of PCT patent application no. PCT/JP2017/037325, filed on Oct. 16, 2017, which claims priority to Japanese patent application no. JP2016-239919 filed on Dec. 9, 2016, the entire contents of which are being incorporated herein by reference.

### BACKGROUND

The present technology generally relates to a battery pack, and more particularly to a battery pack, a vehicle, an electric storage system, an electric power tool, and an electronic device.

In recent years, demand for battery packs has been rapidly expanding in technical fields such as electronic devices such as personal computers and mobile communication terminals, cars such as electric cars, and new energy systems such as wind power generation.

For example, a battery pack is proposed which has a battery protection member including a first plate-shaped part and a second plate-shaped part integrally joined to both ends of the first plate-shaped part in the width direction, and extending in a direction substantially perpendicular to both surfaces of the first plate-shaped part, and a flattened battery with an opening sealed with a film-shaped exterior material, placed on the first plate-shaped part, characterized in that the vertical projection plane of the outer edge of the flattened battery onto the flat plate-shaped part is positioned inside the outer edge of the first plate-shaped part.

In addition, for example, a battery unit is proposed which includes battery cells for charging and discharging with electric power, and a bracket including an outer peripheral wall part for surrounding the outer peripheral side surfaces of the battery cells and a support body provided inside the outer peripheral wall part for supporting the battery cells, where the two battery cells are configured to be inserted into the outer peripheral wall from the front side and rear side of the bracket, and attached to both sides of the support body.

### SUMMARY

The present technology generally relates to a battery pack, and more particularly to a battery pack, a vehicle, an electric storage system, an electric power tool, and an electronic device.

In the conventional technology, there is a possibility the battery packs (battery units) may be incapable of making further improvements in battery characteristics and reliability.

Therefore, battery packs with improved battery characteristics and reliability are desired now.

Accordingly, the present technology has been achieved in view of the foregoing circumstances, and a main object of the technology is to provide a battery pack which has excellent battery characteristics and excellent reliability, and a vehicle, an electric storage system, a power tool, and an electronic device including the battery pack.

As a result of carrying out earnest research in order to solve the above-mentioned object, the inventors have successfully achieved a battery pack which has excellent battery characteristics and excellent reliability, thereby making the present technology matured.

According to an embodiment of the present technology, a battery pack is provided. The battery pack includes at least a battery cell and a holder, where the battery cell is configured to be accommodated in the holder, the holder includes a plate-shaped member having a first placement surface with the battery cell placed thereon, and a first side surface member and a second side surface member that are substantially perpendicular to the first placement surface and extend to the side with the battery cell, and the first side surface member and the second side surface member are larger in length extending to the side with the battery cell than the battery cell in a direction substantially perpendicular to the first placement surface.

According to the present technology, the battery pack may include a substrate, where the substrate is configured to be accommodated in the holder, and the plate-shaped member has a second placement surface with the substrate placed thereon, on an opposite side of the first placement surface.

According to an embodiment of the present technology, a battery pack is provided. The battery pack includes at least a battery cell and a battery cell holder, where the battery cell is configured to be accommodated in the battery cell holder, the battery cell holder includes a plate-shaped member that has a first placement surface with the battery cell placed thereon, and a first side surface member and a second side surface member that are substantially perpendicular to the first placement surface and extend to the side with the battery cell, the first side surface member and the second side surface member are larger in length extending to the side with the battery cell than the battery cell in a direction substantially perpendicular to the first placement surface, the plate-shaped member further has a second placement surface with the battery cell placed on an opposite side of the first placement surface, the battery cell holder includes a third side surface member and a fourth side surface member that are substantially perpendicular to the second placement surface and extend to the side with the battery cell, and the third side surface member and the fourth side surface member are larger in length extending to the side with the battery cell than the battery cell in a direction substantially perpendicular to the second placement surface.

According to an embodiment of the present technology, the battery pack may further include a substrate and a substrate holder, where the substrate is configured to be accommodated in the substrate holder, and the substrate holder includes a first plate-shaped member with a first placement surface with the substrate placed thereon.

According to an embodiment of the present technology, the battery pack may be adapted such that the battery cell holder and the substrate holder are fixed in a direction substantially perpendicular to the plate-shaped member of the battery cell holder and the first plate-shaped member of the substrate holder.

According to an embodiment of the present technology, the battery pack may include a connection tab, where the connection tab is configured to have a first connection connected to a first electrode of the battery cell and a second connection connected to a second electrode of the battery cell, and and the connection tab is integrated by an insulating member.

According to an embodiment of the present technology, the battery pack may include a connection member connected to the connection tab and the substrate, where the connection member has a structure such that the connection member gradationally changes in length in a direction substantially perpendicular to a direction of connections among the connection tab, the connection member, and the substrate.

According to an embodiment of the present technology, the battery cell provided in the battery pack according to the present technology may be a laminate-type battery.

In the battery pack according to an embodiment of the present technology, the holder and the battery cell may be fixed with an adhesive tape.

In the battery pack according to an embodiment of the present technology, the battery cell holder and the battery cell may be fixed with an adhesive tape.

Furthermore, the present technology provides:

a vehicle including the battery pack according to an embodiment of the present technology, a driving force converter configured to receive power supplied from the battery pack to convert the power to a driving force for the vehicle, a driver configured to work in accordance with the driving force, and a vehicle controller;

an electric storage system including, a power storage device including the battery pack according to an embodiment of the present technology, a power consumption device that is configured to be supplied with electric power from the battery pack, a controller configured to control power supply to the power consumption device from the battery pack, and a power generator configured to charge the battery pack;

a power tool including the battery pack according to an embodiment of the present technology and a movable part that is configured to be supplied with electric power from the battery pack; and

an electronic device including the battery pack according to an embodiment of the present technology, where the electronic device is configured to receive power supply from the battery pack.

According to the present technology, a battery pack having excellent battery characteristics and excellent reliability, a vehicle including the battery pack, an electric storage system, an electric power tool, and an electronic device are provided.

It should be understood that the effects described herein are not necessarily to be considered limited, and other suitable properties relating to the present technology may be realized and as further described.

### BRIEF DESCRIPTION OF THE FIGURES

FIG. 1 is a perspective view illustrating a configuration example of a holder provided in a battery pack according to an embodiment of the present technology.

FIG. 2(a) and FIG. 2(b) are diagrams illustrating a configuration example of a holder provided in a battery pack according to an embodiment of the present technology.

FIG. 3(a) and FIG. 3(b) are diagrams illustrating a configuration example of a battery pack according to an embodiment of the present technology.

FIG. 4 is a perspective view illustrating a configuration example of a battery cell holder provided in a battery pack according to an embodiment of the present technology.

FIG. 5 is a perspective view for explaining fixing a battery cell to the battery cell holder according to an embodiment of the present technology.

FIG. 6 is an exploded perspective view illustrating a configuration example of a battery pack according to an embodiment of the present technology.

FIG. 7(a) and FIG. 7(b) are diagrams illustrating a configuration example of the battery pack according to the second embodiment of the present technology.

FIG. 8 is a schematic diagram illustrating a configuration example of a battery pack according to an embodiment of the present technology.

FIG. 9 is a schematic diagram illustrating a configuration example of a battery pack according to an embodiment of the present technology.

FIG. 10(a), FIG. 10(b) and FIG. 10(c) are diagrams illustrating a configuration example of a battery pack according to an embodiment of the present technology.

FIG. 11(a), FIG. 11(b) and FIG. 11(c) are diagrams illustrating a configuration example of a battery pack according to an embodiment of the present technology.

FIG. 12(a), FIG. 12(b) and FIG. 12(c) are diagrams illustrating a configuration example of a connection tab according to an embodiment of the present technology.

FIG. 13 is a diagram illustrating a configuration example of a battery pack according to an embodiment of the present technology.

FIG. 14(a) and FIG. 14(b) are diagrams illustrating a configuration example of a connection member according to an embodiment of the present technology.

FIG. 15(a), FIG. 15(b), FIG. 15(c) and FIG. 15(d) are diagrams illustrating a configuration example of a connection member according to an embodiment of the present technology.

FIG. 16 is a diagram illustrating a configuration example of a battery pack according to an embodiment of the present technology.

FIG. 17 is a diagram illustrating a configuration example of a battery pack according to an embodiment of the present technology.

FIG. 18 is a block diagram illustrating the configuration of an application example (vehicle) of a battery pack according to an embodiment of the present technology.

FIG. 19 is a block diagram illustrating the configuration of an application example (electric storage system) of a battery pack according to an embodiment of the present technology.

FIG. 20 is a block diagram illustrating the configuration of an application example (power tool) of a battery pack according to an embodiment of the present technology.

FIG. 21 is a block diagram illustrating the configuration of an application example (electronic device) of a battery pack according to an embodiment of the present technology.

FIG. 22 is a diagram illustrating the configuration of Application Example (printed circuit board) of a battery pack according to an embodiment of the present technology.

FIG. 23 is a diagram illustrating an example of the configuration of Application Example (universal credit card) of a battery pack according to an embodiment of the present technology.

FIG. 24 is a diagram illustrating an example of the configuration of Application Example (wristband-type activity meter) of a battery pack according to an embodiment of the present technology.

FIG. 25 is a diagram illustrating an example of the configuration of Application Example (wristband-type activity meter) of a battery pack according to an embodiment of the present technology.

FIG. 26 is a diagram illustrating the configuration of Application Example (wristband-type electronic device) of a battery pack according to an embodiment of the present technology.

FIG. 27 is an exploded perspective view illustrating the configuration of Application Example (smartwatch) a battery pack according to an embodiment of the present technology.

FIG. 28 is a diagram illustrating a part of the internal configuration of Application Example (band-type electronic device) of a battery pack according to an embodiment of the present technology.

FIG. 29 is a block diagram illustrating the circuit configuration of Application Example (band-type electronic device) a battery pack according to an embodiment of the present technology.

FIG. 30 is a diagram illustrating a specific example of the configuration of Application Example (eyewear-type terminal) a battery pack according to an embodiment of the present technology.

### DETAILED DESCRIPTION

The present technology generally relates to a battery pack, and more particularly to a battery pack, a vehicle, an electric storage system, an electric power tool, and an electronic device.

As described herein, the present disclosure will be described based on examples with reference to the drawings, but the present disclosure is not to be considered limited to the examples, and various numerical values and materials in the examples are considered by way of example.

The outline of the present technology will be described.

As a conventional method for manufacturing a battery pack, a structure has been adopted in which an integral component is created with a battery cell attached to a holder, and fixed to an exterior case. Since the battery cell (Cell) is expanded by repeating charging and discharging, it is necessary to secure a space for the expansion in the battery pack (battery pack), and in the case of a method of attaching and then fixing the battery cell (or battery cell assembly) to the case, as a means for securing the space for the expansion between the exterior case and the battery cell, a method of securing the space in such a form that supports both ends is adopted by attaching a tape for use in bonding to the case, with a thick component such as a cushioning material brought close to the ends. In this case, due to the increased number of parts and the increased number of attachment steps, and the adhesion to only the both ends of the cell excluding the central part of the battery cell, for example, the adhesion strength is decreased by the reduced adhesion area. The holder or battery cell holder provided in the battery pack according to the present technology forms a structure suspended with a battery cell attached to the holder or the battery cell holder, thereby making it possible to easily create a space for expansion between the case and the cell, and also making it possible to provide a wide adhesion area because of the planar adhesion.

As for fixing each component constituting the battery cell, examples of the countermeasure in the case of desiring the adoption of a structure that has a substrate disposed on the upper surface of the battery cell include the addition of an insulating component between the battery cell and the substrate and determination of a substrate positioning method. In particular, in the case of using a connector for output, it is also necessary to improve the accuracy of the positional relation.

On the other hand, the use of the holder or battery cell holder provided in the battery pack according to the present technology makes it possible to dispose the substrate or the like on the placement surface (adhesion surface) and back side (opposite surface) of the battery cell, and thus deal with the case.

The holder provided in the battery pack according to the present technology can dispose the substrate in parallel to the battery cell, rather than place (bond) only the battery cell. Also in the combination of a battery cell holder and a substrate holder provided in the battery pack according to the present technology, the substrate and the battery cell can be arranged in parallel. According to the present technology, connection members, connection tabs, and the like can be placed in the direction of extending a cell lead, components such as a connection members and connection tabs can be positioned freely with a holder or a battery cell holder therebetween, and the battery cell, the substrate, the connection member, the connection tab, and the like can be insulated from each other.

The present technology is based on the foregoing circumstances, and according to the present technology, contributions can be made to the improvement or maintenance of excellent battery characteristics and reliability of a battery pack, with the achievement of, for example, impact resistance improved and energy density improved by a battery pack including at least a battery cell and a holder, where the battery cell is housed in the holder, the holder includes a plate-shaped member that has a first placement surface with the battery cell placed thereon, and a first side surface member and a second side surface member that are substantially perpendicular to the first placement surface and extend to the side with the battery cell placed, and the first side surface member and the second side surface member are larger in length extending to the side with the battery cell placed than the battery cell in a direction substantially perpendicular to the first placement surface, or a battery pack including at least a battery cell and a battery cell holder, where the battery cell is housed in the battery cell holder, the battery cell holder includes a plate-shaped member that has a first placement surface with the battery cell placed thereon, and a first side surface member and a second side surface member that are substantially perpendicular to the first placement surface and extend to the side with the battery cell placed, where the first side surface member and the second side surface member are larger in length extending to the side with the battery cell placed than the battery cell in a direction substantially perpendicular to the first placement surface, the plate-shaped member has a second placement surface with the battery cell placed, on the back side of the first placement surface, the battery cell holder includes a third side surface member and a fourth side surface member that are substantially perpendicular to the second placement surface and extend to the side with the battery cell placed, and the third side surface member and the fourth side surface member are larger in length extending to the side with the battery cell placed than the battery cell in a direction substantially perpendicular to the second placement surface.

The battery pack according to the present technology is formed by, for example, housing a battery such as a laminate-type lithium ion secondary battery in a holder or a battery cell holder. This battery pack is used for vehicles, electric storage systems, power tools, electronic devices, and the like.

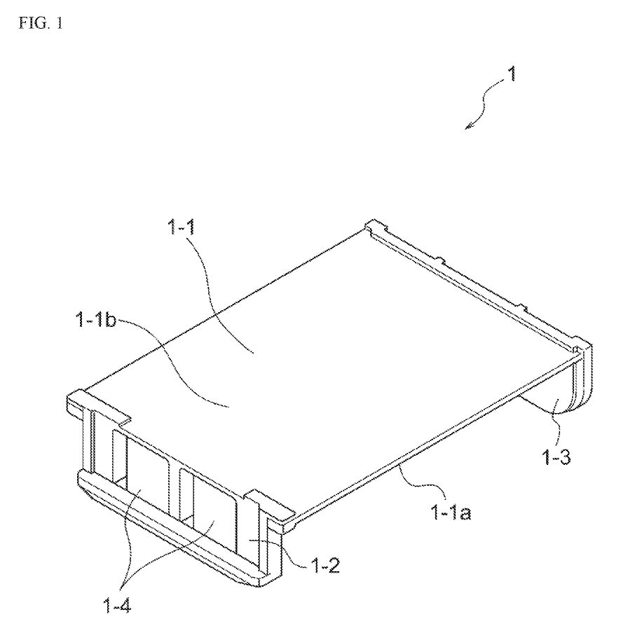

A battery pack 4 according to the first embodiment (Example 1 of the battery pack) of the present technology will be described with reference to FIGS. 1 to 3.

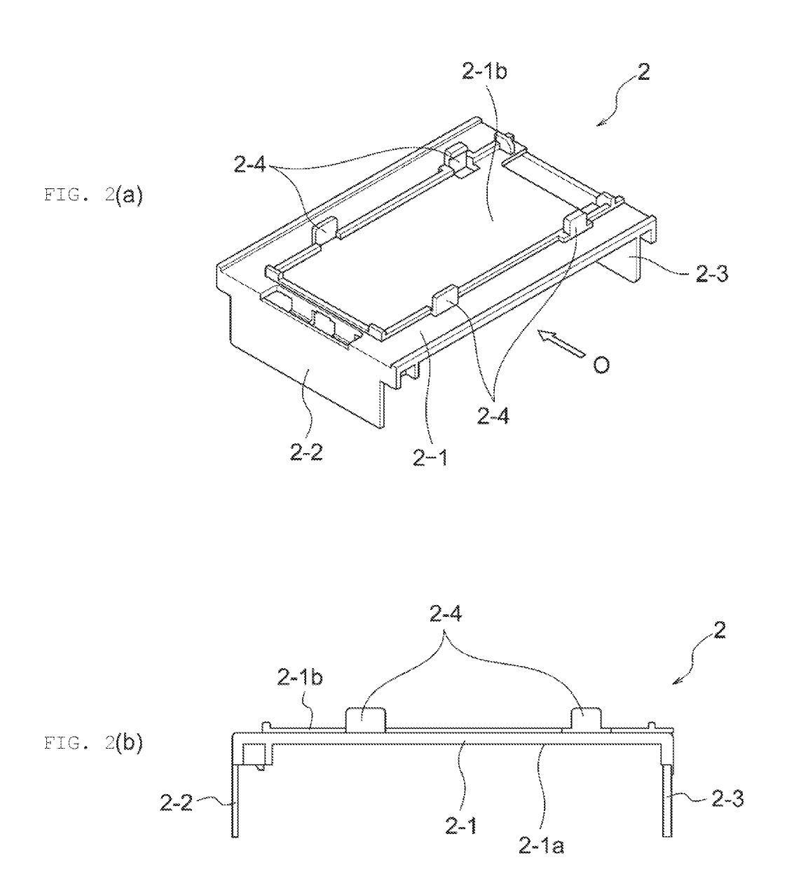

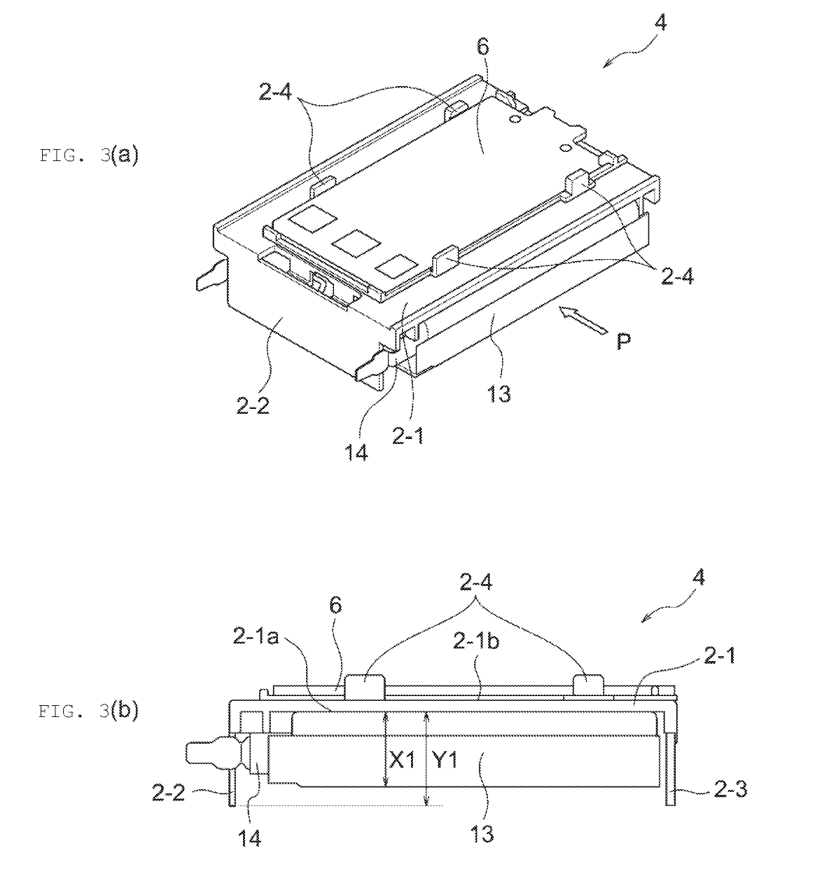

FIG. 1 is a perspective view of a holder 1. FIG. 2(a) is a perspective view of a holder 2 provided in the battery pack 4, and FIG. 2(b) is a cross-sectional view of the holder 2 from the direction of a white arrow O in FIG. 2(a). FIG. 3(a) is a perspective view of the battery pack 4, and FIG. 3(b) is a cross-sectional view of the battery pack 4 from the direction of a white arrow P in FIG. 3(a).

As shown in FIG. 3, the battery pack 4 includes a battery cell 13 and a holder 2. The battery cell 13 is housed in the holder 2. The holder 2 includes a plate-shaped member 2-1 that has a first placement surface 2-1a with a battery cell 13 placed, and a first side surface member 2-2 and a second side surface member 2-3 which are substantially perpendicular to the first placement surface 2-1a and extend to the side with the battery cell 13 placed. The battery cell 13 is fixed to the first placement surface 2-1a. The battery cell 13 is fixed to the first placement surface 2-1a, for example, with an adhesive tape (not shown in FIG. 3) interposed therebetween.

From the viewpoint of ease of handling and the like, the adhesive tape is preferably a double-sided adhesive tape.

As shown in FIG. 3(b), the length Y1 of the first side surface member 2-2 and second side surface member 2-3 extending to the side with the battery cell 13 placed is larger than the length X1 of the battery cell 13 in a direction substantially perpendicular to the first placement surface 2-1a. Y1 is longer than X1, and thus when the battery cell 13 is fixed to the first placement surface 2-1a, the battery cell 13 is suspended from the holder 2, and the space corresponding to the length of Y1-X1 can be secured. Due to the presence of the space, even when the battery cell 13 is expanded by, for example, charge and discharge or the like, there is no problem such as a safety problem or a defective appearance.

The battery pack 4 makes, due to the presence of the space mentioned above, it possible to protect the battery cell 13, thereby providing excellent impact resistance. In addition, the holder 2 makes it possible to insulate the battery cell 13 from a substrate 6, thereby improving the energy density.

As shown in FIG. 3, the battery pack 4 may further include the substrate 6 (also referred to as a circuit board 6, the same applies hereinafter). The substrate 6 is housed in the holder 2. The plate-shaped member 2-1 of the holder 2 has a second placement surface 2-1b for placing the substrate 6 on the back side of the first placement surface 2-1a. The substrate 6 is fixed by hook parts 2-4 to the second placement surface 2-1b. Details of the fixing method will be described later. In addition, as shown in FIG. 3, the battery pack 4 may include a connection tab 14 connected to the battery cell 13. The battery cell 13 is connected to the substrate 6 with the connection tab 14 and a connection member (not shown in FIG. 3) interposed therebetween.

It should be understood that the battery pack 4 may include the holder 1 shown in FIG. 1, instead of the holder 2. Furthermore, in the case of including the substrate 6, the substrate 6 may be housed in a substrate holder 8, which will be described later, and the holder 1 and the substrate holder 8 may be fixed. Examples of the fixing method include a method in which the holder 1 and the substrate holder 8 are fitted to each other by, for example, snap fitting or the like.

The battery pack 4 may further include a connection tab 10 (14), a connection member 7, and/or an exterior case (an upper half exterior case 5 and a lower half exterior case 15). The connection tab 10 (14), the connection member 7, and/or the exterior case (the upper half exterior case 5 and the lower half exterior case 15) will be described in detail in the second embodiment (Example 2 of the battery pack).

The holder 1 shown in FIG. 1 includes a plate-shaped member 1-1 that has a first placement surface 1-1a with a battery cell (not shown) placed, and a first side surface member 1-2 and a second side surface member 1-3 which are substantially perpendicular to the first placement surface 1-1a and extend to the side with the battery cell placed. The battery cell is fixed to the first placement surface 1-1a. The battery cell is fixed to the first placement surface 1-1a, for example, with an adhesive tape (not shown in FIG. 1) interposed therebetween. From the viewpoint of ease of handling and the like, the adhesive tape is preferably a double-sided adhesive tape. The material of the holder 1 is not particularly limited, and examples thereof can include insulating materials such as plastics. In addition, the material of the holder 1 may be a material containing a metal powder or carbon, with high thermal conductivity. The use of such a material makes it possible to release the heat generated from the battery cell 13 (9) to the outside in an efficient manner. Alternatively, the material of the holder 1 may be a material containing a glass fiber or a carbon filler. In such a case, the mechanical strength of the holder 1 can be increased.

Although not explicitly shown in FIG. 1, the length of the first side surface member 1-2 and second side surface member 1-3 extending to the side with the battery cell placed is larger than the length of the battery cell in a direction substantially perpendicular to the first placement surface. With a space formed by the larger length, even when the battery cell is expanded by, for example, charge and discharge or the like, there is no problem such as a safety problem or a defective appearance.

As described above, for example, the substrate holder 8 may be fixed to a second placement surface 1-1b, which is the back side of the first placement surface 1-1a, and the substrate 6 may be housed in the substrate holder 8.

In the case of increasing the number of battery cells with the use of the holder 1, it is possible to achieve a design in accordance with the number of battery cells by increasing the number of the stages of holders 1 to which the battery cells are fixed (bonded). In this case, for example, the substrate holder 8 which will be described later may be fixed to the second placement surface 1-1b of the holder 1 at the uppermost stage among the plurality of holders 1, and the substrate 6 may be housed in the substrate holder 8.

The two openings 1-4 shown in FIG. 1 are provided for further improving the heat dissipation, and as long as the further improvement of the heat dissipation can be achieved by another means, there is no need for the holder 1 to have the two openings 1-4.

The holder 2 shown in FIG. 2 has no battery cell 9 (13) housed therein, and the constituent members and the like of the holder 2 are adopted as described above with reference to FIG. 3, and descriptions of the holder 2 will be thus omitted here. In addition, the material of the holder 2 is the same as the material of the holder 1 described above.

In the case of increasing the number of battery cells with the use of the holder 2, it is possible to achieve a design in accordance with the number of battery cells by, for example, using the part at the uppermost stage as the holder 2 (with the battery cell 13 and the substrate 6 housed therein) and stacking multiple stages holders 1 under the holder 2.

The battery cell 13 (9) is not particularly limited, and may be a known battery, and examples of the battery include a primary battery such as a manganese dry battery, an alkaline manganese dry battery, and a lithium primary battery, and a secondary battery such as a nickel-cadmium battery, a nickel-metal hydride battery, a nickel-zinc battery, a lead battery, a lithium secondary battery, a lithium ion secondary battery, and a lithium ion polymer secondary battery, and preferably, a lithium ion secondary battery is used. In addition, the battery cell 13 (9) may be a laminate-type battery or a cylindrical type battery, but preferably a laminate-type battery is used.

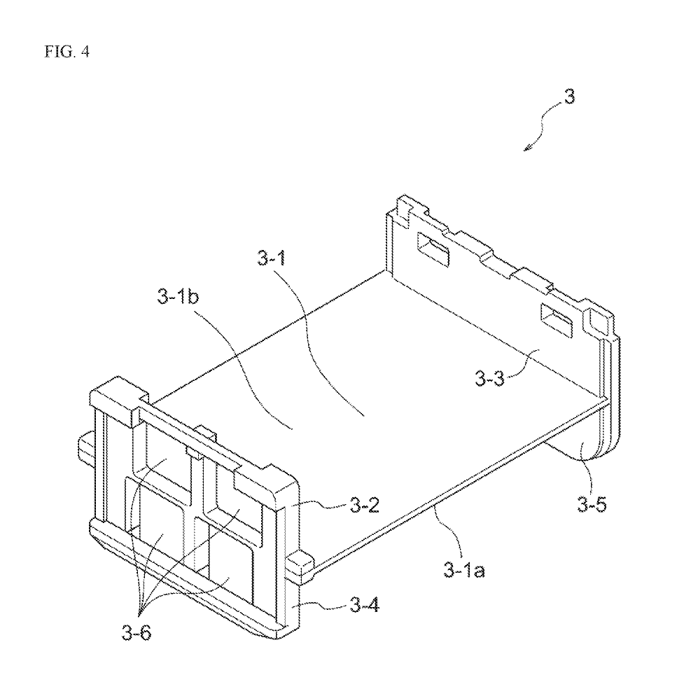

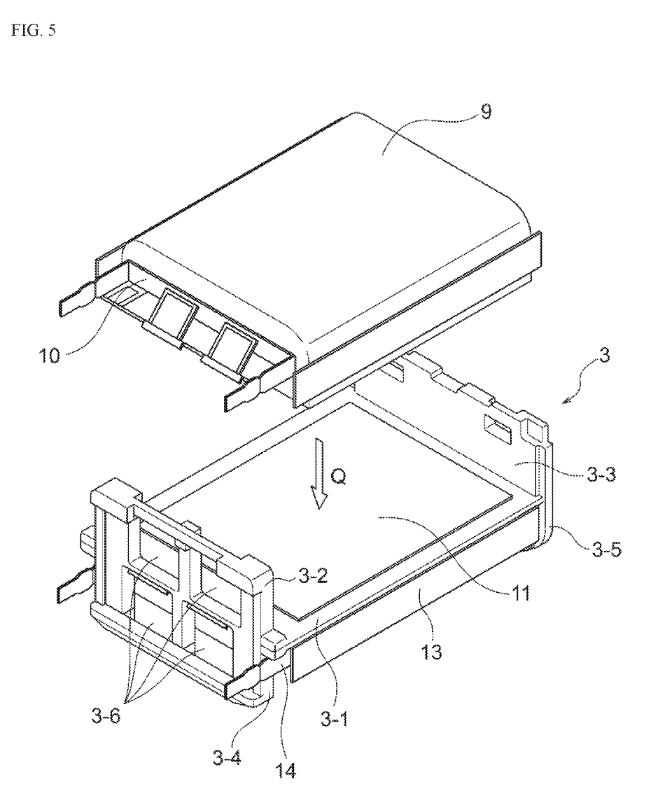

The battery pack 40 (41 to 46) of the second embodiment (Example 2 of the battery pack) according to the present technology will be described with reference to FIGS. 4 to 11.

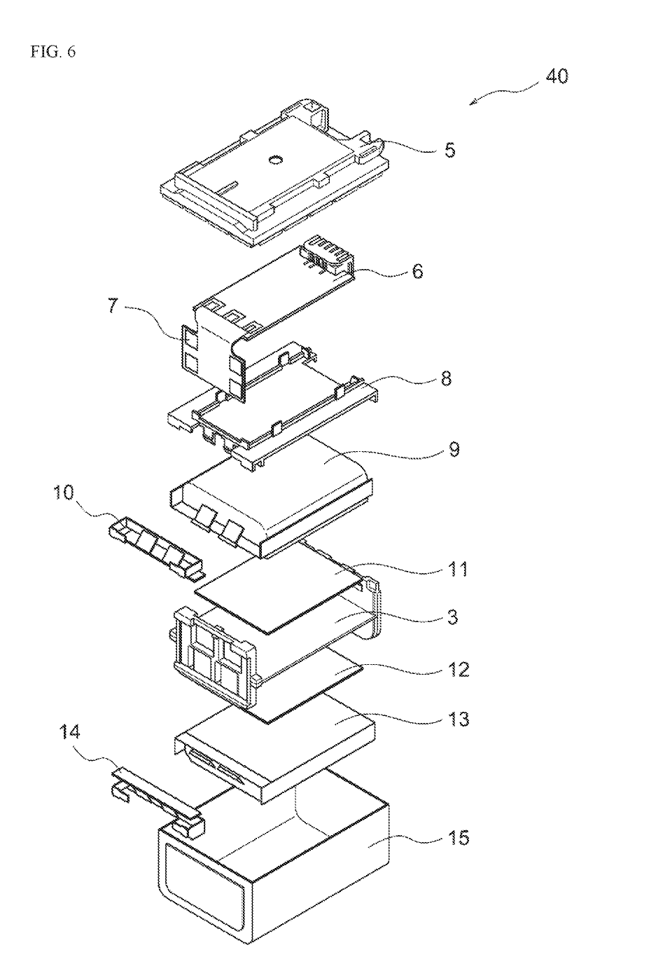

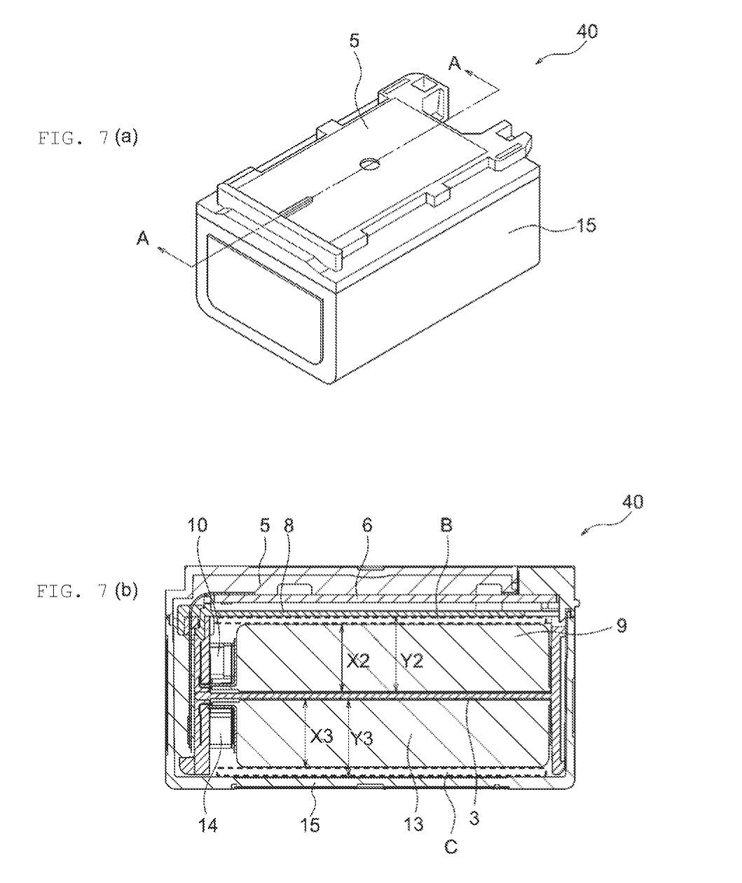

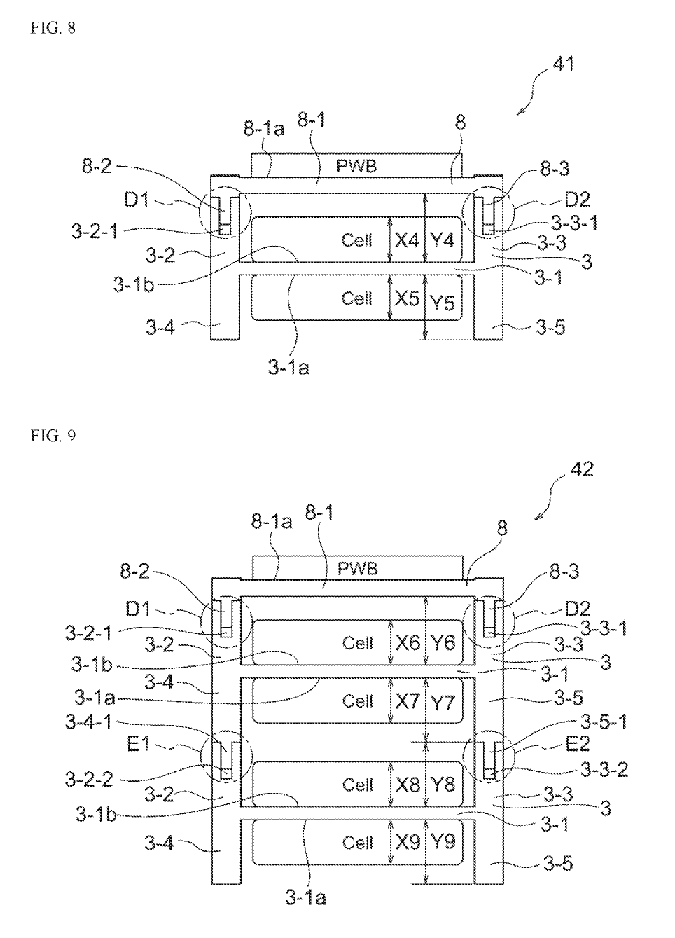

FIG. 4 is a perspective view of a battery cell holder 3. FIG. 5 is a perspective view for explaining fixing the battery cell 9 to the battery cell holder 3. FIG. 6 is an exploded perspective view of the battery pack 40. FIG. 7(a) is a perspective view of the battery pack 40, and FIG. 7(b) is a cross-sectional view taken along the line A-A shown in FIG. 7(a). FIG. 8 is a schematic diagram of the battery pack 41, and FIG. 9 is a schematic diagram of the battery pack 42.

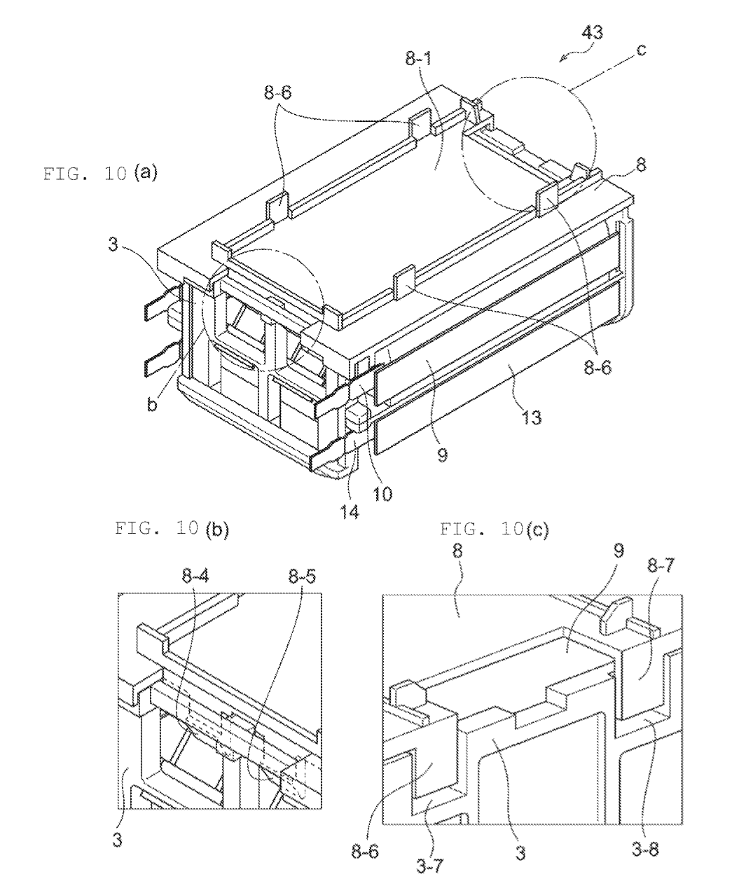

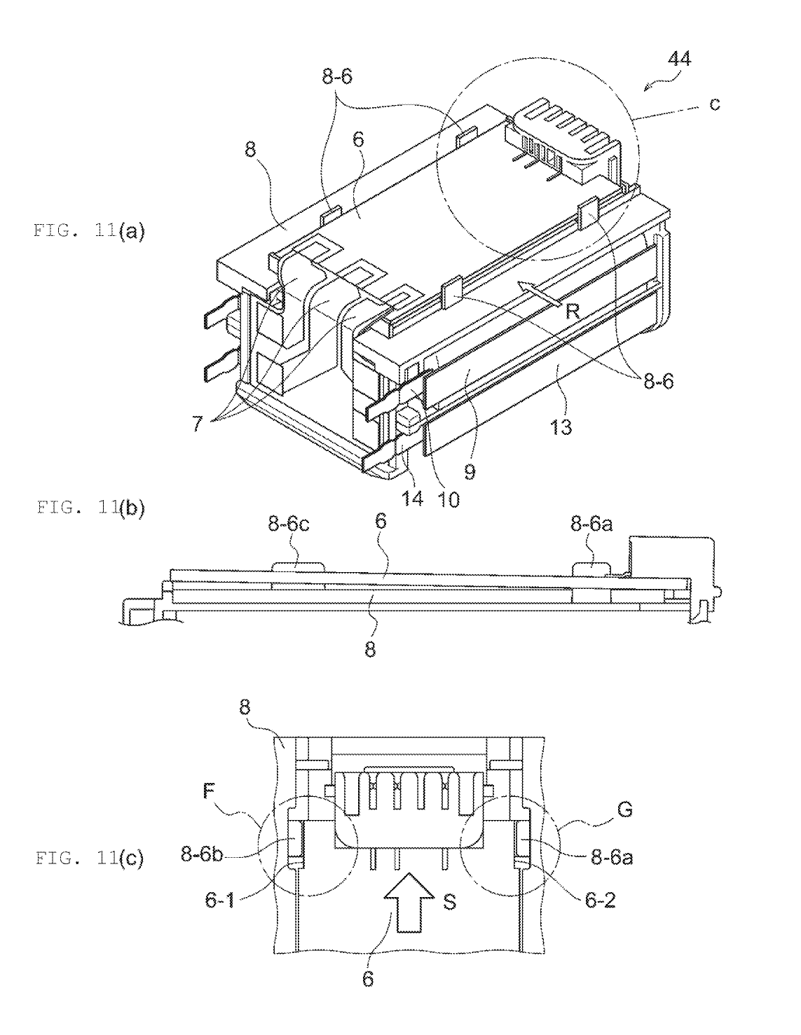

FIG. 10(a) is a perspective view of the battery pack 43, FIG. 10(b) is an enlarged view of an enlargement of the circular part b shown in FIG. 10(a), and FIG. 10(c) is an enlarged view of an enlargement of the circular part c shown in FIG. 10(a). FIG. 11(a) is a perspective view of the battery pack 44. FIG. 11(b) is a cross-sectional view of a part of the battery pack 44 from the direction of a white arrow R in FIG. 11(a), which is a diagram for the explanation of fixing the substrate 6 to the substrate holder 8. FIG. 11(c) is an enlarged view of an enlargement of the circular part c shown in FIG. 11(a), which is a diagram for the explanation of fixing the substrate 6 to the substrate holder 8.

As shown in FIG. 6, the battery pack 40 includes at least the battery cells 9 and 13 and the battery cell holder 3. The battery cells 9 and 13 are housed in the battery cell holder 3.

As shown in FIGS. 4 and 6, the battery cell holder 3 includes a plate-shaped member 3-1 that has a first placement surface 3-1a with the battery cell 13 placed, and a first side surface member 3-4 and a second side surface member 3-5 which are substantially perpendicular to the first placement surface 3-1a and extend to the side with the battery cell 13 placed. Furthermore, the plate-shaped member 3-1 has, on the back side of the first placement surface 3-1a, a second placement surface 3-1b with the battery cell 9 placed, and the battery cell holder 3 includes a third side surface member 3-2 and a fourth side surface member 3-3 which are substantially perpendicular to the second placement surface 3-1b and extend to the side with the battery cell 9 placed. The battery cell 13 is fixed to the first placement surface 3-1a, for example, with the double-sided the adhesive tape 12 interposed therebetween. The battery cell 9 is fixed to the second placement surface 3-1b, for example, with a double-sided the adhesive tape 11 interposed therebetween.

A method of fixing the battery cell 9 to the battery cell holder 3 will be specifically described with reference to FIG. 5. The double-sided adhesive tape 11 is attached in advance to the second placement surface 3-1b of the battery cell holder 3. Then, in the direction of a white arrow Q, the battery cell 9 is attached and fixed to the double-sided adhesive tape 11. The bottom surface of the battery cell 9 and the battery cell holder 3 are bonded with the adhesive tape interposed therebetween. The bottom surface of the battery cell 9 to be bonded is preferably, of the two bottom surfaces of the battery cell 9 (the upper surface and the lower surface which are substantially perpendicular to the direction of the white arrow Q in FIG. 5), a bottom surface (that is, the lower bottom surface in FIG. 9) substantially perpendicular to the respective sides (the sides in the longitudinal direction in FIG. 5) of the two side surfaces opposed to respective sites R (shoulders R) of the two side surfaces substantially perpendicular to the connection tab 10, and also substantially perpendicular to the bottom surfaces. This method makes it possible to fix the battery cell 9 (13) to the battery cell holder 3 with high accuracy. It should be understood that as long as the battery cell 9 (13) can be fixed to the battery cell holder 3 with high accuracy, any method may be used other than the above-described method with the use of the double-sided adhesive tape 11 (12).

In the battery cell holder 3, the length of the first side surface member 3-4 and second side surface member 3-5 extending to the side with the battery cell 13 placed is larger than the length of the battery cell 13 in a direction substantially perpendicular to the first placement surface 3-1a. The length of the third side surface member 3-2 and fourth side surface member 3-3 extending to the side with the battery cell 9 placed is larger than the length of the battery cell 9 in a direction substantially perpendicular to the second placement surface 3-1b. The foregoing will be described with reference to FIG. 7(b) that is a cross-sectional view taken along the line A-A shown in FIG. 7(a). The length Y3 of the first side surface member 3-4 and second side surface member 3-5 extending to the side with the battery cell 13 placed is larger than the length X3 of the battery cell 13 in a direction substantially perpendicular to the first placement surface 3-1a. Y3 is longer than X3, and thus when the battery cell 13 is fixed to the first placement surface 3-1a, the battery cell 13 is suspended from the battery cell holder 3, and the space C corresponding to the length of Y3-X3 can be secured. Due to the presence of the space C, even when the battery cell 13 is expanded by, for example, charge and discharge or the like, there is no problem such as a safety problem or a defective appearance.

Likewise, the length Y2 of the third side surface member 3-2 and fourth side surface member 3-3 extending to the side with the battery cell 9 placed is larger than the length X2 of the battery cell 9 in a direction substantially perpendicular to the second placement surface 3-1b. Y2 is longer than X2, and thus when the battery cell 9 is fixed to the first placement surface 3-1b, the battery cell 9 is suspended from the battery cell holder 3, and the space B corresponding to the length of Y2-X2 can be secured. Due to the presence of the space B, even when the battery cell 9 is expanded by, for example, charge and discharge or the like, there is no problem.

The battery pack 40 makes, due to the presence of the spaces B and C mentioned above, it possible to protect the battery cells 9 and 13, thereby providing excellent impact resistance, and the spatial distance between the spaces B and C is set to be an optimum value, thereby making it possible to improve energy density. In addition, the holder 3 makes it possible to insulate the battery cell 9 from the battery cell 13, and furthermore, the battery cell holder 3 and the substrate holder 8 make it possible to insulate the battery cell 13 from the substrate 6, thereby improving safety.

FIG. 8 is a schematic diagram of the battery pack 41, and the battery pack 41 includes at least a single-stage battery cell holder 3, two Cells (battery cells) housed in the single-stage battery cell holder 3 by placement respectively on the placement surface 3-1a and placement surface 3-1b of a plate-shaped member 3-1, the single-stage substrate holder 8, and a PWB (substrate) housed in the single-stage substrate holder 8 by placement on a placement surface 8-1a of a plate-shaped member 8-1.

In the battery pack 41, the length Y5 of the first side surface member 3-4 and second side surface member 3-5 extending to the side with the Cell (battery cell) placed is larger than the length X5 of the Cell (battery cell) in a direction substantially perpendicular to the first placement surface 3-1a. Y5 is longer than X5, and thus when the Cell is fixed to the first placement surface 3-1a, the Cell is suspended from the battery cell holder 3, and the space corresponding to the length of Y5-X5 can be secured. Due to the presence of the space, even when the Cell (battery cell) is expanded by, for example, charge and discharge or the like, there is no problem.

Likewise, the length Y4 of the third side surface member 3-2 and fourth side surface member 3-3 extending to the side with the Cell (battery cell) placed is larger than the length X4 of the Cell (battery cell) in a direction substantially perpendicular to the second placement surface 3-1b. Y4 is longer than X4, and thus when the Cell is fixed to the first placement surface 3-1b, the Cell is suspended from the battery cell holder 3, and the space corresponding to the length of Y4-X4 can be secured. Due to the presence of the space, even when the Cell (battery cell) is expanded by, for example, charge and discharge or the like, there is no problem such as a safety problem or a defective appearance.

The battery cell holder 3 and the substrate holder 8 are fixed in a direction substantially perpendicular to the plate-shaped member 3-1 of the battery cell holder 3 and the plate-shaped member 8-1 of the substrate holder 8 such that a recess 3-2-1 of the battery cell holder 3 and a recess 3-3-1 of the battery cell holder 3 are fitted by snap fitting respectively to a projection 8-2 (a part D1 in FIG. 8) of the substrate holder and a projection 8-3 (a part D2 in FIG. 8) of the substrate holder. This fixing makes it possible to improve the position accuracy of the two Cells (battery cells) and PWB (substrate). It should be understood that while the fixing through the fitting by snap fitting has been described herein, any fixing method may be adopted as long as the positional accuracy of the Cells (battery cells) and PWB (substrate) can be improved.

FIG. 9 is a schematic diagram of the battery pack 42, and the battery pack 42 includes at least two stages of battery cell holders 3, four Cells (battery cells) housed in the two stages of battery cell holders 3 by placement respectively on the two placement surfaces 3-1a and two placement surfaces 3-1b of two plate-shaped members 3-1, the single-stage substrate holder 8, and a PWB (substrate) housed in the single-stage substrate holder 8 by placement on a placement surface 8-1a of a plate-shaped member 8-1. For the battery pack 42, the battery cell holder 3 is composed of two stages. The battery pack 42 may be composed of a single-stage substrate holder 8 and a triple-stage or more battery cell holder 3. In addition, the battery pack 42 is composed of an even number of battery cells.

Of the two battery cell holders 3 included in the battery pack 42, in the lower battery cell holder 3 in FIG. 9, the length Y9 of the first side surface member 3-4 and second side surface member 3-5 extending to the side with the Cell (battery cell) placed is larger than the length X9 of the Cell (battery cell) in a direction substantially perpendicular to the first placement surface 3-1a. Y9 is longer than X9, and thus when the Cell is fixed to the first placement surface 3-1a, the Cell is suspended from the battery cell holder 3, and the space corresponding to the length of Y5-X5 can be secured. Due to the presence of the space, even when the Cell (battery cell) is expanded by, for example, charge and discharge or the like, there is no problem such as a safety problem or a defective appearance.

Likewise, the length Y8 of the third side surface member 3-2 and four side surface member 3-3 extending to the side with the Cell (battery cell) placed is larger than the length X8 of the Cell (battery cell) in a direction substantially perpendicular to the second placement surface 3-1b. Y8 is longer than X8, and thus when the Cell is fixed to the first placement surface 3-1b, the Cell is suspended from the battery cell holder 3, and the space corresponding to the length of Y8-X8 can be secured. Due to the presence of the space, even when the Cell (battery cell) is expanded by, for example, charge and discharge or the like, there is no problem such as a safety problem or a defective appearance.

Of the two stages of battery cell holders 3 included in the battery pack 42, in the upper battery cell holder 3 in FIG. 9, the length Y7 of the first side surface member 3-4 and second side surface member 3-5 extending to the side with the Cell (battery cell) placed is larger than the length X7 of the Cell (battery cell) in a direction substantially perpendicular to the first placement surface 3-1a. Y7 is longer than X7, and thus when the Cell is fixed to the first placement surface 3-1a, the Cell is suspended from the battery cell holder 3, and the space corresponding to the length of Y7-X7 can be secured. Due to the presence of the space, even when the Cell (battery cell) is expanded by, for example, charge and discharge or the like, there is no problem such as a safety problem or a defective appearance.

Likewise, the length Y6 of the third side surface member 3-2 and four side surface member 3-3 extending to the side with the Cell (battery cell) placed is larger than the length X6 of the Cell (battery cell) in a direction substantially perpendicular to the second placement surface 3-1b. Y6 is longer than X6, and thus when the Cell is fixed to the first placement surface 3-1b, the Cell is suspended from the battery cell holder 3, and the space corresponding to the length of Y6-X6 can be secured. Due to the presence of the space, even when the Cell (battery cell) is expanded by, for example, charge and discharge or the like, there is no problem such as a safety problem or a defective appearance.

The two stages of battery cell holders 3 are fixed to each other in a direction substantially perpendicular to the respective plate-shaped member 3-1 of the two battery cell holder 3 such that a recess 3-2-2 of the lower battery cell holder 3 in FIG. 9 and a recess 3-3-2 of the lower battery cell holder 3 in FIG. 9 are fitted by snap fitting respectively to a projection 3-4-1 (a part E1 in FIG. 9) of the upper battery cell holder 3 in FIG. 9 and a projection 3-5-1 (a part E2 in FIG. 9) of the upper battery cell holder 3 in FIG. 9. This fixing makes it possible to improve the position accuracy of the four Cells (battery cells) and PWB (substrate). It should be understood that while the fixing through the fitting by snap fitting has been described herein, any fixing method may be adopted as long as the positional accuracy of the four Cells (battery cells) can be improved.

Further, the upper battery cell holder 3 and the substrate holder 8 in FIG. 9 are fixed in a direction substantially perpendicular to the plate-shaped member 3-1 of the battery cell holder 3 and the plate-shaped member 8-1 of the substrate holder 8 such that a recess 3-2-1 of the battery cell holder 3 and a recess 3-3-1 of the battery cell holder 3 are fitted by snap fitting respectively to a projection 8-2 (a part D1 in FIG. 9) of the substrate holder and a projection 8-3 (a part D2 in FIG. 9) of the substrate holder. This fixing makes it possible to improve the position accuracy of the two Cells (battery cells) and PWB (substrate). It should be understood that while the fixing through the fitting by snap fitting has been described herein, any fixing method may be adopted as long as the positional accuracy of the two Cells (battery cells) and PWB (substrate) can be improved.

With reference to FIG. 10 (battery pack 43), fixing the battery cell holder 3 and the substrate holder 8 will be described in more detail.

FIG. 10(b) is the enlarged view of the enlargement of the circular part b shown in FIG. 10(a). With reference to FIG. 10(b), the battery cell holder 3 and the substrate holder 8 are fixed such that a projection 8-4 and a projection 8-5 of the substrate holder 8 are fitted by snap fitting to a recess of the battery cell holder 3. This fixing improves the position accuracy of the battery cell holder 3 and substrate holder 8.

FIG. 10(c) is the enlarged view of the enlargement of the circular part c shown in FIG. 10(a). With reference to FIG. 10(c), the battery cell holder 3 and the substrate holder 8 are fixed such that a projection 8-6 of the substrate holder 8 and a projection 8-7 of the substrate holder 8 are fitted by snap fitting respectively to a recess 3-7 of the battery cell holder 3 and a recess 3-8 of the battery cell holder 3. This fixing improves the position accuracy of the battery cell holder 3 and substrate holder 8.

The battery cell holder 3 shown in FIG. 4 has no battery cells 9 and 13 housed therein, and the constituent members and the like of the battery cell holder 3 are adopted as described above, and descriptions of the holder 3 will be thus omitted here. The four openings 3-6 shown in FIG. 4 are provided for further improving the heat dissipation, and as long as the further improvement of the heat dissipation can be achieved by another means, there is no need for the battery cell holder 3 to have the four openings 3-6. The material of the battery cell holder 3 is not particularly limited, and examples thereof can include insulating materials such as plastics. In addition, the material of the battery cell holder 3 may be a material containing a metal powder or carbon, with high thermal conductivity. The use of such a material makes it possible to release the heat generated from the battery cell 13 (9) to the outside in an efficient manner. Alternatively, the material of the battery cell holder 3 may be a material containing a glass fiber or a carbon filler. In such a case, the mechanical strength of the battery cell holder 3 can be increased.

As described above, the battery pack 40 (44) includes at least the battery cells 9 and 13 and the battery cell holder 3, and may further include the substrate 6 and the substrate holder 8 for fixing and then housing the substrate 6. A method of fixing the substrate 6 to the substrate holder 8 will be described herein with respect to FIG. 11. As shown in FIG. 11(b), the substrate 6 is fixed to the substrate holder 8, with hook parts 8-6a, 8-6b (not shown in FIG. 11(b)), 8-6c, and 8-6d (not shown in FIG. 11(b)) of the substrate holder 8, interposed therebetween. This fixing improves the position accuracy of the substrate 6 and substrate holder 8. The material of the substrate holder 8 is not particularly limited, and examples thereof can include insulating materials such as plastics. In addition, the material of the substrate holder 8 may be a material containing a metal powder or carbon, with high thermal conductivity. The use of such a material makes it possible to release the heat generated from the substrate 6 to the outside in an efficient manner. Alternatively, the material of the substrate holder 8 may be a material containing a glass fiber or a carbon filler. In such a case, the mechanical strength of the substrate holder 8 can be increased.

Further, to provide a further description with reference to FIG. 11(c), a notch 6-1 of the substrate 6 is fitted to the hook part 8-6b, further, a notch 6-2 of the substrate 6 is fitted to the hook part 8-6a, and the substrate 6 is slid in the direction of a white arrow S to fix the substrate 6 to the substrate holder 8.

The battery pack 40 may further include the connection tab 10 (14).

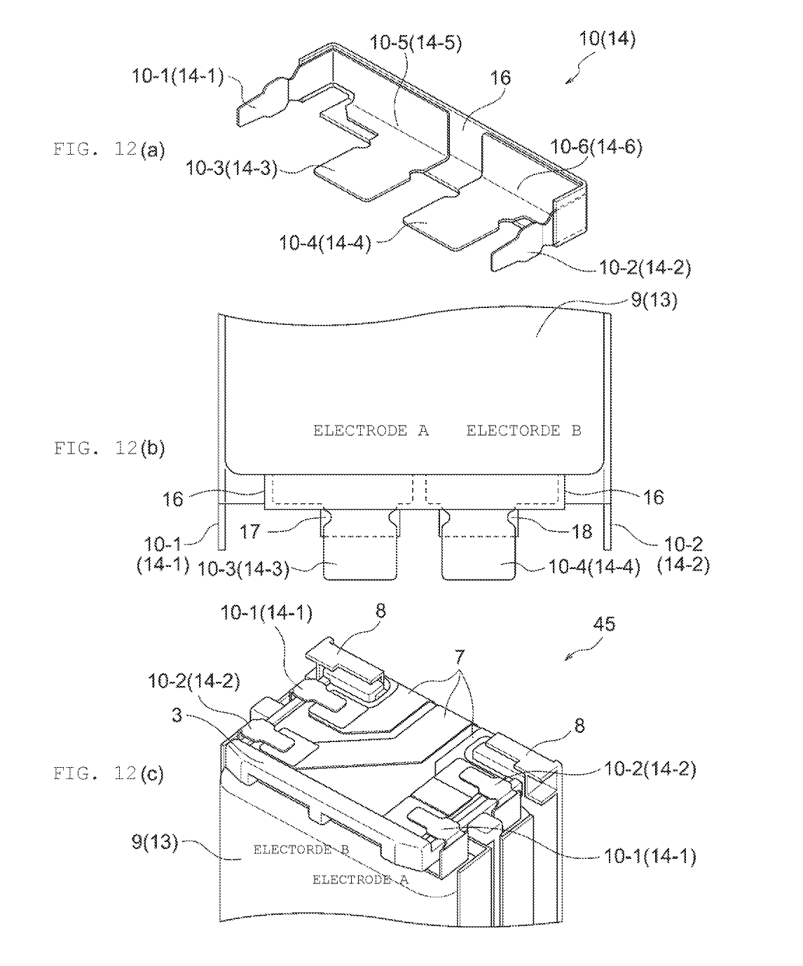

FIG. 12 is a diagram illustrating the connection tab 10 (14). FIG. 12(a) is a perspective view of the connection tab 10 (14). FIG. 12(b) is a diagram illustrating the connection tab and the battery cell 9 (13) connected. FIG. 12(c) is a perspective view of the battery pack 45, which is a diagram illustrating the connection tab 10 and the connection member 7 connected.

The connection tab 10 is configured to have a first connection 10-5 (14-5) connected to one electrode (electrode A in FIG. 12) of the battery cell 9 (13) and a second connection 10-6 (14-6) connected to the other electrode (electrode B in FIG. 12) of the battery cell 9 (13), integrated by an insulating member 16. The insulating member 16 may be any optional material as long as the material has an insulation property, but is preferably a resin material.

The connection tab 10 is connected to electrode tabs, thereby making it possible to improve the assembly accuracy, and thus reduce the variation in input to the substrate 6 (connection member 7), while maintaining the position accuracy of the soldered sites. When the tab of one electrode (electrode A in FIG. 12) and the tab of the other electrode (electrode B in FIG. 12) are isolated individually, the assembly accuracy is, even with the use of a jig, decreased as compared with the connection tab 10, which may affect subsequent connections.

The first connection 10-5 (14-5) includes a substantially rectangular part 10-3 (14-3) and a tip part 10-1 (14-1). The substantially rectangular part 10-3 (14-3) is connected to a lead 17 of the electrode A, and the tip part 10-1 (14-1) is connected to the connection member 7. On the other hand, the second connection 10-6 (14-6) includes a substantially rectangular part 10-4 (14-4) and a tip part 10-2 (14-2). The substantially rectangular part 10-4 (14-4) is connected to a lead 18 of the electrode B, and the tip part 10-2 (14-2) is connected to the connection member 7.

The battery pack 40 (46) may further include the connection member 7 that connects to the connection tab 10 (14) and the substrate 6. As for the connection member 7, the connection member 7 changes gradationally in length in a direction substantially perpendicular to the directions of the connections among the connection tab 10 (14), the connection member 7, and the substrate 6.

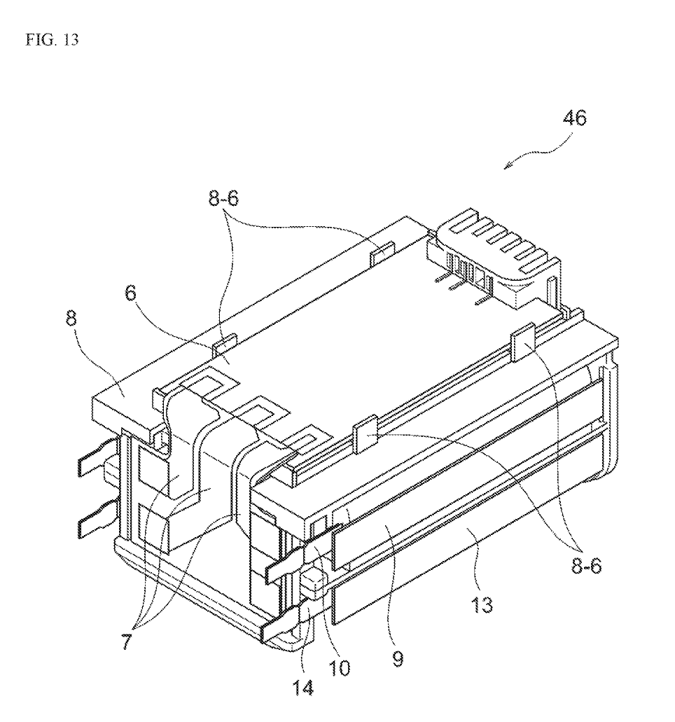

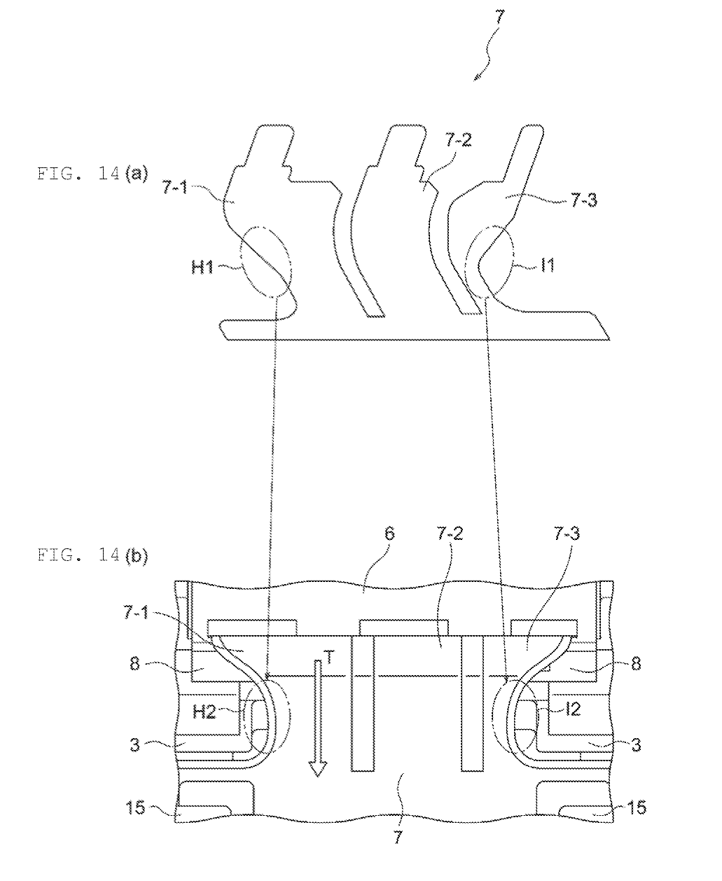

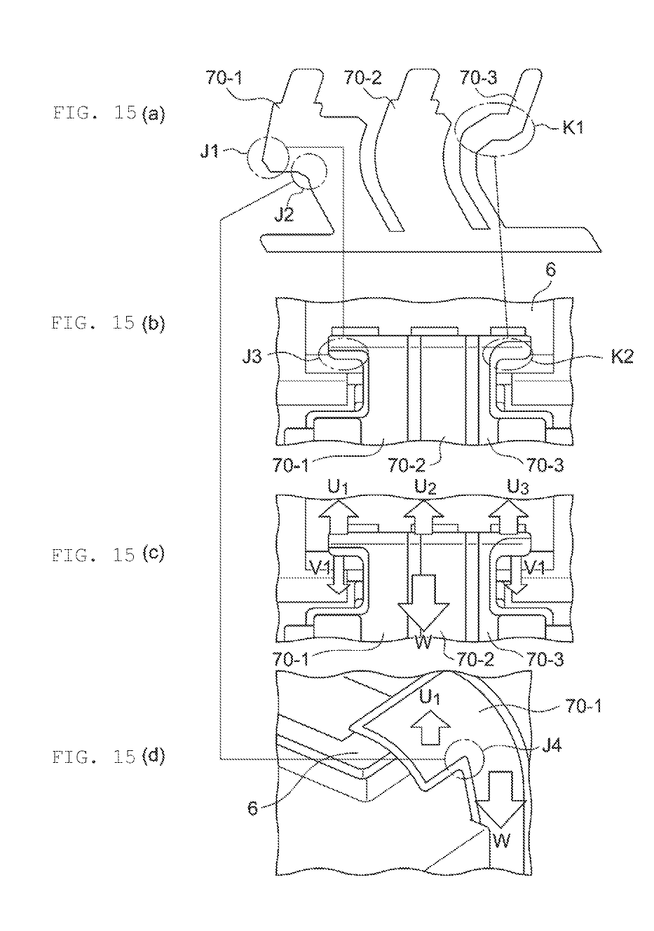

FIG. 13 is a perspective view of the battery pack 46 including the connection member 7. FIG. 14(a) is a front view of the connection member 7. FIG. 14(b) is a diagram illustrating the connection member 7 connected to the substrate 6.

As just described, gradationally changing the length of the connection member 7 in a direction substantially perpendicular to the directions of the connections among the connection tab 10 (14), the connection member 7 and the substrate 6 will not fracture the connection member 7, because no stress is concentrated on the bent portions of the connection member 7 formed in connecting the connection tab 10 (14), and the substrate 6. The connection member 7 can be bent and then used in connecting the connection member 7 to the substrate 6, and the degree of freedom is thus improved for disposing the battery cells 9 and 13 and the substrate 6. For example, as shown in FIG. 13, the substrate 6 can be provided so as to be stacked on the battery cells 9 and 13. Conventionally, the substrate is disposed parallel to the cell in the direction in which a cell lead is extended, or with a tab folded, the substrate is disposed to so as to be folded up by 90°. In addition, as shown in FIG. 13, in the case of placing the substrate on the upper surface of a battery cell, a connection therebetween with a tab, a lead wire, or the like is adopted, but there is a need for insulation between the battery cell and the substrate, it is difficult to create a connection between the lead and the cell, and there has been an increased number of accessory parts and thus an increase in thickness dimension. However, these problems are avoided as mentioned above by the use the connection member 7. Further, the conductor part inside the connection member 7 also has a degree of freedom such that the position of the output site can be switched between left and right while keeping the position of the input site as it is, and as an effect, the polarity of the battery cell can be reversed (that is, the orientation of the battery cell can be reversed).

As shown in FIG. 14(a), the connection member 7 is composed of a connection member 7-1, a connection member 7-2, and a connection member 7-3. An elliptical part H1 in FIG. 14(a) corresponds to a constricted part of the connection member 7-1, and an elliptical part H2 in FIG. 14(b) corresponds to the bent portion of the connection member 7-1, formed in connecting the connection member 7-1 to the substrate 6. In addition, an elliptical part I1 in FIG. 14(a) corresponds to a constricted part of the connection member 7-3, and an elliptical part I2 in FIG. 14(b) corresponds to the bent portion of the connection member 7-3, formed in connecting the connection member 7-3 to the substrate 6.

Referring to the elliptical part H1, the constricted part of the connection member 7-1 changes gradationally in thickness to provide an angle R. Further, referring to the elliptical part H2, at the bent portion of the connection member 7-1, in the T direction of a white arrow, the connection member 7-1 changes gradationally in length in a direction substantially perpendicular to the directions of the connections among the connection tab 10 (14), the connection member 7, and the substrate 6 (a direction substantially perpendicular to the T direction).

Likewise, referring to the elliptical part I1, the constricted part of the connection member 7-3 changes gradationally in thickness to provide an angle R. Further, referring to the elliptical part I2, at the bent portion of the connection member 7-3, in the T direction of a white arrow, the connection member 7-3 changes gradationally in length in a direction substantially perpendicular to the directions of the connections among the connection tab 10 (14), the connection member 7, and the substrate 6 (a direction substantially perpendicular to the T direction).

FIG. 15 is a diagram illustrating an example of a conventional connection member 70. FIG. 15(a) is a front view of the connection member 70. As shown in FIG. 15(a), the connection member 70 is composed of a connection member 70-1, a connection member 70-2, and a connection member 70-3. FIGS. 15(b) to 15(d) are diagrams illustrating the connection member 70 connected to the substrate 6.

In the conventional connection member 70, for example, in accordance with the convenience of the exterior case shape, as indicated by elliptical parts J1 to J2 and an elliptical part K1 in FIG. 15(a), the connection member 70 is configured like a narrowed neck, and shaped to be bent at the neck part, and there is thus concern about fracture due to stress concentration.

Parts indicated by elliptical parts J3 and K2 in FIG. 15(b) may cause floating from the bent shapes. This floating is caused because, after the member is bent, the force is poorly transmitted to the bent portions. More specifically, white arrows V1 and V2 are weak against a white arrow W, thus causing elliptical parts J3 and K2 and a circular part J4 to float up due to springback along with white arrows U1 to U3.

The battery pack 40 (41 to 46) may further include an exterior case. As shown in FIG. 6, the exterior case is composed of the upper half exterior case 5 and the lower half exterior case 15. The exterior case is prepared by attaching the upper half exterior case 5 and the lower half exterior case 15 with fastening screws (not shown). The materials of the upper half exterior case 5 and the lower half exterior case 15 are not particularly limited, and examples of the material can include insulating materials such as plastics, for example.

The exterior case (battery pack) may be restricted to the direction of stacking inner cells in order to achieve a design (an expansion of a shoulder R) for the appearance of the battery pack. However, the use of the connection member 7 increases the degree of freedom for the wiring, thereby allowing an arrangement such that the shoulder R of the battery cell corresponds to the appearance R of the battery pack in question, the appearance R (shoulder R) can be expanded.

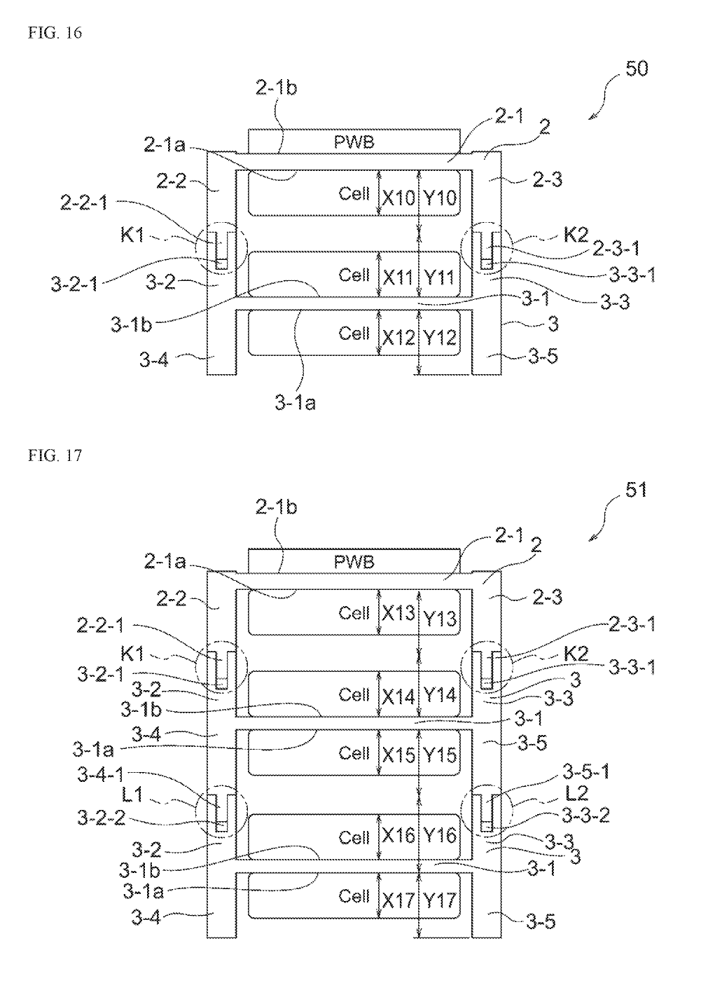

Battery packs 50 to 51 of the third embodiment (a modified example of the battery pack) according to the present technology will be described with reference to FIGS. 16 to 17.

FIG. 16 is a schematic diagram of the battery pack 50, and the battery pack 50 includes at least: one holder 2, and in the holder 2, one Cell (battery cell) housed by placement on the placement surface 2-1a of a plate-shaped member 2-1, one PWB (substrate) housed by placement on a placement surface 2-1b of the plate-shaped member 2-1; and one battery cell holder 3, and in the battery cell holder 3, two Cells (battery cells) housed by placement respectively on the placement surface 3-1a and placement surface 3-1b of a plate-shaped member 3-1.

In the battery pack 50, the length Y12 of the first side surface member 3-4 and second side surface member 3-5 extending to the side with the Cell (battery cell) placed is larger than the length X12 of the Cell (battery cell) in a direction substantially perpendicular to the first placement surface 3-1a. Y12 is longer than X12, and thus when the Cell is fixed to the first placement surface 3-1a, the Cell is suspended from the battery cell holder 3, and the space corresponding to the length of Y12-X12 can be secured. Due to the presence of the space, even when the Cell (battery cell) is expanded by, for example, charge and discharge or the like, there is no problem such as a safety problem or a defective appearance.

In addition, in the battery pack 50, the length Y10 of the first side surface member 2-2 and second side surface member 2-3 extending to the side with the Cell (battery cell) placed is larger than the length X10 of the Cell (battery cell) in a direction substantially perpendicular to the first placement surface 2-1a. Y10 is longer than X10, and thus when the Cell is fixed to the first placement surface 2-1a, the Cell is suspended from the holder 2, and the space corresponding to the length of Y10-X10 can be secured. Due to the presence of the space, even when the Cell (battery cell) is expanded by, for example, charge and discharge or the like, there is no problem such as a safety problem or a defective appearance.

The holder 2 and the battery cell holder 3 are fixed in a direction substantially perpendicular to the plate-shaped member 3-1 of the battery cell holder 3 and the plate-shaped member 2-1 of the holder 2 such that a recess 3-2-1 of the battery cell holder 3 and a recess 3-3-1 of the battery cell holder 3 are fitted by snap fitting respectively to a projection 2-2-1 (a part K1 in FIG. 16) of the holder 2 and a projection 2-3-1 (a part K2 in FIG. 16) of the holder 2. This fixing makes it possible to improve the position accuracy of the three Cells (battery cells) and PWB (substrate). It should be understood that while the fixing through the fitting by snap fitting has been described herein, any fixing method may be adopted as long as the positional accuracy of the three Cells (battery cells) and PWB (substrate) can be improved.

FIG. 17 is a schematic diagram of the battery pack 51, and the battery pack 51 includes at least: a single-stage holder 2, and in the single-stage holder 2, one Cell (battery cell) housed by placement on the placement surface 2-1a of a plate-shaped member 2-1, one PWB (substrate) housed by placement on a placement surface 2-1b of the plate-shaped member 2-1; and two battery cell holders 3, and in the two battery cell holders 3, four Cells (battery cells) housed by placement respectively on the two placement surface 3-1a and two placement surface 3-1b of two plate-shaped members 3-1. For the battery pack 51, the battery cell holder 3 is composed of two stages. The battery pack 51 may be composed of a single-stage holder 2 and a triple-stage or more battery cell holder 3. In addition, the battery pack 51 is composed of an odd number of battery cells.

Of the two stages of battery cell holders 3 included in the battery pack 51, in the lower battery cell holder 3 in FIG. 17, the length Y17 of the first side surface member 3-4 and second side surface member 3-5 extending to the side with the Cell (battery cell) placed is larger than the length X17 of the Cell (battery cell) in a direction substantially perpendicular to the first placement surface 3-1a. Y17 is longer than X17, and thus when the Cell is fixed to the first placement surface 3-1a, the Cell is suspended from the battery cell holder 3, and the space corresponding to the length of Y17-X17 can be secured. Due to the presence of the space, even when the Cell (battery cell) is expanded by, for example, charge and discharge or the like, there is no problem such as a safety problem or a defective appearance.

Likewise, the length Y16 of the third side surface member 3-2 and four side surface member 3-3 extending to the side with the Cell (battery cell) placed is larger than the length X16 of the Cell (battery cell) in a direction substantially perpendicular to the second placement surface 3-1b. Y16 is longer than X16, and thus when the Cell is fixed to the first placement surface 3-1b, the Cell is suspended from the battery cell holder 3, and the space corresponding to the length of Y16-X16 can be secured. Due to the presence of the space, even when the Cell (battery cell) is expanded by, for example, charge and discharge or the like, there is no problem such as a safety problem or a defective appearance.

Of the two stages of battery cell holders 3 included in the battery pack 51, in the upper battery cell holder 3 in FIG. 17, the length Y15 of the first side surface member 3-4 and second side surface member 3-5 extending to the side with the Cell (battery cell) placed is larger than the length X15 of the Cell (battery cell) in a direction substantially perpendicular to the first placement surface 3-1a. Y15 is longer than X15, and thus when the Cell is fixed to the first placement surface 3-1a, the Cell is suspended from the battery cell holder 3, and the space corresponding to the length of Y15-X15 can be secured. Due to the presence of the space, even when the Cell (battery cell) is expanded by, for example, charge and discharge or the like, there is no problem such as a safety problem or a defective appearance.

Likewise, the length Y14 of the third side surface member 3-2 and four side surface member 3-3 extending to the side with the Cell (battery cell) placed is larger than the length X14 of the Cell (battery cell) in a direction substantially perpendicular to the second placement surface 3-1b. Y14 is longer than X14, and thus when the Cell is fixed to the first placement surface 3-1b, the Cell is suspended from the battery cell holder 3, and the space corresponding to the length of Y14-X14 can be secured. Due to the presence of the space, even when the Cell (battery cell) is expanded by, for example, charge and discharge or the like, there is no problem such as a safety problem or a defective appearance.

The two stages of battery cell holders 3 are fixed to each other in a direction substantially perpendicular to the respective plate-shaped member 3-1 of the two battery cell holder 3 such that a recess 3-2-2 of the lower battery cell holder 3 in FIG. 17 and a recess 3-3-2 of the lower battery cell holder 3 in FIG. 17 are fitted by snap fitting respectively to a projection 3-4-1 (a part L1 in FIG. 17) of the upper battery cell holder 3 in FIG. 17 and a projection 3-5-1 (a part L2 in FIG. 17) of the upper battery cell holder 3 in FIG. 17. This fixing makes it possible to improve the position accuracy of the four Cells (battery cells) and PWB (substrate). It should be understood that while the fixing through the fitting by snap fitting has been described herein, any fixing method may be adopted as long as the positional accuracy of the four Cells (battery cells) can be improved.

Further, the upper battery cell holder 3 and the holder 2 in FIG. 17 are fixed in a direction substantially perpendicular to the plate-shaped member 3-1 of the battery cell holder 3 and the plate-shaped member 2-1 of the holder 2 such that a recess 3-2-1 of the battery cell holder 3 and a recess 3-3-1 of the battery cell holder 3 are fitted by snap fitting respectively to a projection 2-2-1 (a part K1 in FIG. 17) of the holder 2 and a projection 2-3-1 (a part K2 in FIG. 17) of the holder 2. This fixing makes it possible to improve the position accuracy of the three Cells (battery cells) and PWB (substrate). It should be understood that while the fixing through the fitting by snap fitting has been described herein, any fixing method may be adopted as long as the positional accuracy of the three Cells (battery cells) and PWB (substrate) can be improved.

Applications of the battery pack will be described in detail below.

The application of the battery pack is not particularly limited, as long as the secondary battery is applied to machines, devices, instruments, apparatuses, systems, and the like (assembly of multiple devices or the like) that can use the battery pack as a driving power supply, a power storage source for reserve of power, or the like. The battery pack for use as a power supply may be a main power supply (a power supply that is used preferentially), or an auxiliary power supply (in place of a main power supply, or a power supply that is used by switching from a main power supply). In the case of using the battery pack as an auxiliary power supply, the type of the main power supply is not limited to the battery pack.

Here are applications of the battery pack, for example: notebook personal computers, tablet computers, mobile phones (for example, smartphones), personal digital assistants (Personal Digital Assistants: PDA), imaging devices (for example, digital still cameras, digital video cameras, etc.), audio instruments (for example, portable audio players), game machines, cordless phone handsets, electronic books, electronic dictionaries, radios, headphones, navigation systems, memory cards, pacemakers, hearing aids, and electronic devices (including portable electronic devices) such as lighting devices, toys, medical devices, and robots; portable life instruments such as electric shavers; storage devices such as backup power supplies and memory cards; power tools such as electric drills and electric saws; battery packs used for notebook-type personal computers or the like as a detachable power supply; medical electronic devices such as pacemakers and hearing aids; vehicles used for electric cars (including hybrid cars); and electric storage systems such as a domestic battery system that stores electric power in preparation for emergency or the like. Of course, the application may be any other application than the foregoing.

Above all, it is effective to apply the battery pack to a vehicle, an electric storage system, a power tool, an electronic device, and the like. This is because, since excellent battery characteristics are required, the use of the battery pack according to the present technology can improve the performance in an effective manner. It should be understood that the vehicle is a vehicle that operates (travels) with the battery pack as a driving power supply, and may be a vehicle (a hybrid car or the like) also provided with a driving source other than the battery pack as mentioned above. Examples of the electric storage system, for example, an electric storage system for residential use, which is a system that uses the battery pack as a power storage source. For an electric storage system, electric power is stored in the battery pack which serves as a power storage source, thus making it possible to use power consumption devices, for example, home electric appliances through the use of the electric power. The power tool is a tool which makes a movable part (such as a drill, for example) movable with the battery pack as a driving power supply. The electronic device is a device that performs various functions with the battery pack as a driving power supply (power supply source).

Some application examples of the battery pack according to the present technology will be specifically described herein. It should be understood that the configuration of each application example described below is just considered by way of example, and can be changed appropriately.

A vehicle according to the fourth embodiment of the present technology is a vehicle including a battery pack according to the present technology, a driving force (converter) that converts the electric power supplied from the battery pack according to the present technology, to a driving force, a (driver) that works in accordance with the driving force, and a vehicle control device (controller) having a processor. The vehicle according to the fourth embodiment of the present technology includes the battery pack according to the present technology, which has excellent battery characteristics and excellent reliability, thus leading to improvements in vehicle performance and reliability.

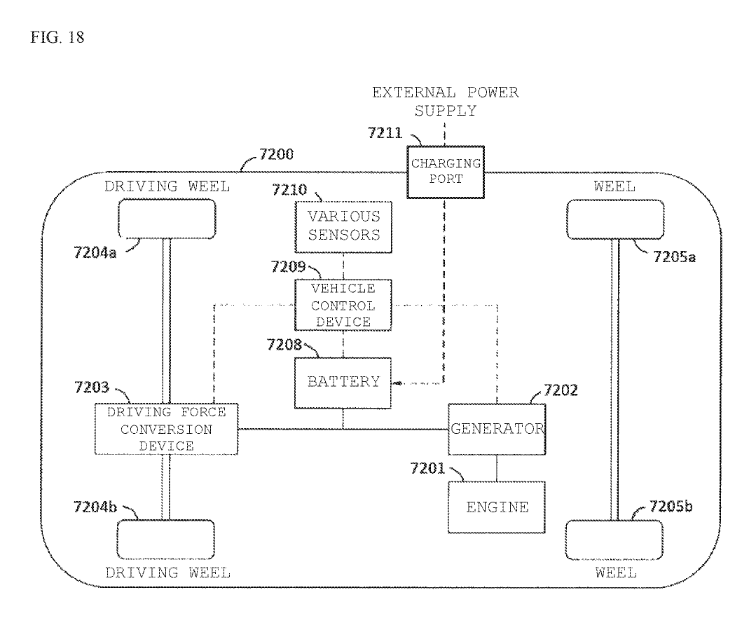

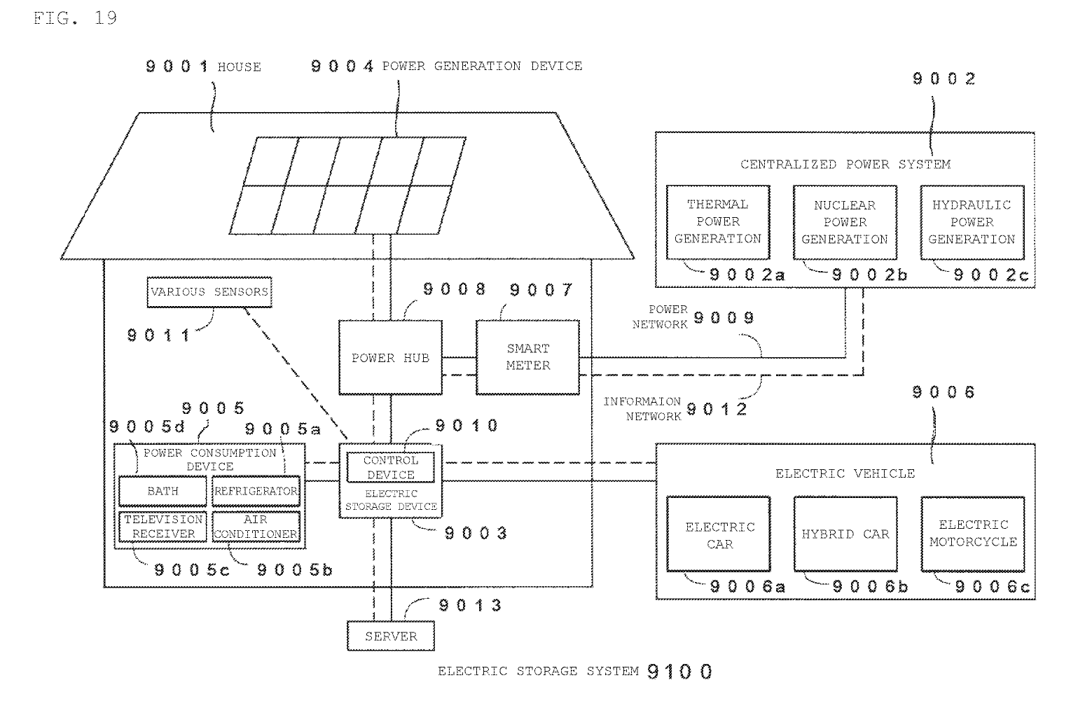

A vehicle according to the fourth embodiment of the present technology will be described below with reference to FIG. 18.

FIG. 18 schematically illustrates an example of the configuration of a hybrid vehicle that adopts a series hybrid system to which the present technology is applied. The series hybrid system is intended for a vehicle that runs on an electric power-driving force conversion device, with the use of electric power generated by a generator driven by an engine, or the electric power stored once in the battery.

The hybrid vehicle 7200 carries an engine 7201, a generator 7202, the electric power-driving force conversion device 7203, a driving wheel 7204a, a driving wheel 7204b, a wheel 7205a, a wheel 7205b, a battery 7208, a vehicle control device 7209 (controller) having a processor, various sensors 7210, and a charging port 7211. The power storage device (not shown) is applied to the battery 7208.

The hybrid vehicle 7200 travels with the electric power-driving force conversion device 7203 as a power source. An example of the electric power-driving force conversion device 7203 is a motor. The electric power-driving force conversion device 7203 is operated by the electric power of the battery 7208, and the torque of the electric power-driving force conversion device 7203 is transmitted to the driving wheels 7204a and 7204b. It should be understood that the electric power-driving force conversion device 7203 (converter) can be applied to both an alternate-current motor and a direct-current motor by using direct current-alternate current (DC-AC) or reverse conversion (AC-DC conversion) in a required location. The various sensors 7210 control the engine rotation speed via the vehicle control device 7209, and control the position (throttle position) of a throttle valve, not shown. The various sensors 7210 include a speed sensor, an acceleration sensor, an engine rotation speed sensor, and the like.

The torque of the engine 7201 is transmitted to the generator 7202, and the torque makes it possible to reserve, in the battery 7208, the electric power generated by the generator 7202.

When the hybrid vehicle is decelerated by a braking mechanism, not shown, the resistance force during the deceleration is applied as torque to the electric power-driving force conversion device 7203, and the regenerative electric power generated by the electric power-driving force conversion device 7203 is reserved in the battery 7208 by the torque.

The battery 7208 is connected to a power source outside the hybrid vehicle, thereby making it also possible to receive electric power supply from the external power supply with the charging port 211 as an input port, and then reserve the received power.

Although not shown, the vehicle may be provided with an information processing device that performs information processing related to vehicle control, based on information on the secondary battery. Examples of such an information processing device include, for example, an information processing device that displays the remaining battery level, based on information on the remaining level of the battery.

It should be understood that as an example, the series hybrid vehicle has been described above, which runs on the motor with the use of the electric power generated by the generator driven by the engine, or the electric power stored once in the battery. However, the present disclosure can be also effectively applied to parallel hybrid vehicles which use the outputs of both an engine and a motor as a driving source, and appropriately switch three systems of running on only the engine, running on only the motor, and running on the engine and the motor. Furthermore, the present technology can be also effectively applied to so-called electric vehicles that run on driving by only a driving motor without using any engine.

An electric storage system according to the fifth embodiment of the present technology an electric storage system including a power storage device including a battery pack according to the present technology, a power consumption device that is supplied with electric power from the battery pack according to the present technology, a control device that controls power supply to the power consumption device from the battery pack, and a power generation device that charges the battery pack. The electric storage system according to the fifth embodiment of the present technology includes the battery pack according to the present technology, which has excellent battery characteristics and excellent reliability, thus leading to improvements in electric storage system performance and reliability.

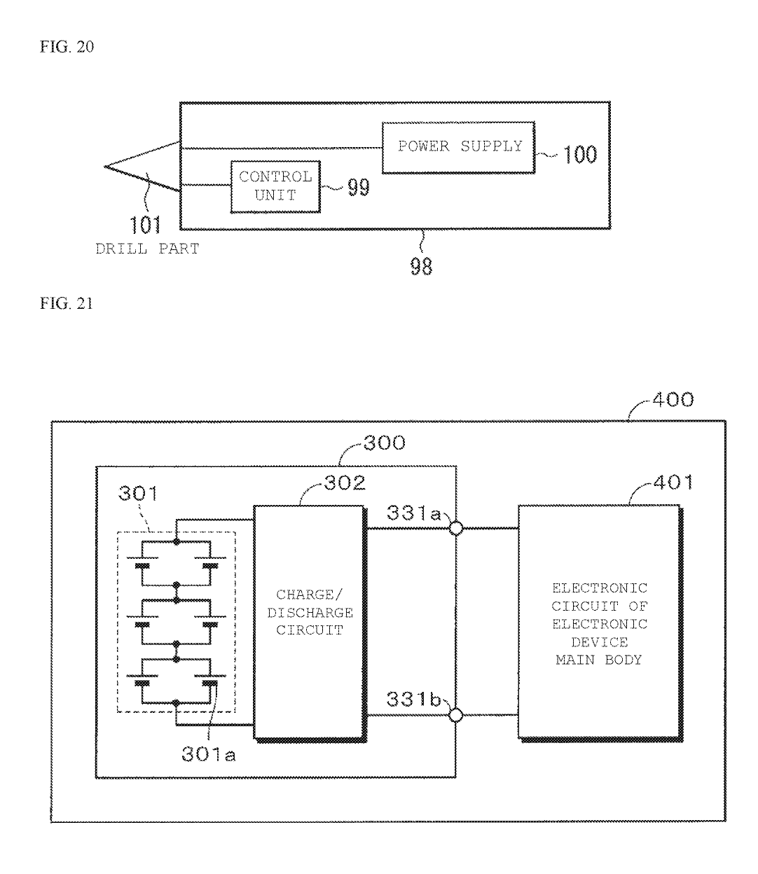

An electric storage system for residential use, which is an example of the electric storage system according to the fifth embodiment of the present technology, will be described below with reference to FIG. 19.

For example, in an electric storage system 9100 for a house 9001, electric power is supplied to an electric storage device 9003 via a power network 9009, an information network 9012, a smart meter 9007, a power hub 9008, and the like, from a centralized power system 9002 such as a thermal power generation 9002a, a nuclear power generation 9002b, and a hydraulic power generation 9002c. At the same time, electric power is supplied to the electric storage device 9003 from an independent power source such as a home power generation device 9004. The electric power supplied to the electric storage device 9003 is stored. Electric power for use in the house 9001 is supplied through the use of the electric storage device 9003. The same electric storage system can be used not only for the house 9001 but also for buildings.

The house 9001 is provided with the power generation device 9004, a power consumption device 9005, the electric storage device 9003, a control device 9010 for controlling the respective devices, the smart meter 9007, and sensors 9011 for acquiring various types of information. The respective devices are connected by the power network 9009 and the information network 9012. As the power generation device 9004, a solar cell, a fuel cell, or the like is used, and electric power generated is supplied to the power consumption device 9005 and/or the electric storage device 9003. The power consumption device 9005 refers to a refrigerator 9005a, an air conditioner 9005b, a television receiver 9005c, a bath 9005d, and the like. Furthermore, the power consumption device 9005 includes an electric vehicle 9006. The electric vehicle 9006 refers to an electric car 9006a, a hybrid car 9006b, and an electric motorcycle 9006c.

The above-described battery unit according to the present disclosure is applied to the electric storage device 9003. The electric storage device 9003 is composed of a secondary battery or a capacitor.

For example, the device is composed of a lithium-ion battery. The lithium ion battery may be stationary or may be used in the electric vehicle 9006. The smart meter 9007 has the function of measuring the commercial power usage and transmitting the measured usage to the electric power company. The power network 9009 may be any one or combination of direct-current power feeding, alternate-current power feed, and contactless power feeding.

The various sensors 9011 are, for example, a human sensor, an illuminance sensor, an object detection sensor, a power consumption sensor, a vibration sensor, a contact sensor, a temperature sensor, an infrared sensor, and the like. Information acquired by the various sensors 9011 is transmitted to the control device 9010. With the information from the sensor 9011, weather condition, the human condition, etc. can be grasped to control the power consumption device 9005 automatically controlled, and thus minimize the energy consumption. Furthermore, the control device 9010 can transmit information on the house 9001 to an external electric power company or the like via the Internet.

The power hub 9008 performs processing such as power line branching and DC/AC conversion. Examples of the communication method of the information network 9012 connected to the control device 9010 include a method of using a communication interface such as a UART (Universal Asynchronous Receiver-Transmitter: transmission/reception circuit for asynchronous serial communication), and a method of using a sensor network in accordance with a wireless communication standard, such as Bluetooth (registered trademark), ZigBee, and Wi-Fi. The Bluetooth (registered trademark) system, which is applied to multimedia communication, can perform one-to-many connection communication. The ZigBee uses the physical layer of the IEEE (Institute of Electrical and Electronics Engineers) 802.15.4. The IEEE 802.15.4 is a name of a short range wireless network standard referred to as PAN (Personal Area Network) or W (Wireless) PAN.

The control device 9010 is connected to an external server 9013. This server 9013 may be managed by any of the house 9001, an electric power company, and a service provider. The information transmitted and received by the server 9013 is, for example, power consumption information, life pattern information, power charges, weather information, natural disaster information, and information on electric power trade. These pieces of information may be transmitted and received from a power consumption device (for example, a television receiver) in the home, but may be transmitted and received from a device outside the home (for example, a mobile phone). These pieces of information may be displayed on a device that has a display function, for example, a television receiver, a mobile phone, a personal digital assistant (PDA), or the like.

The control device 9010 (controller) that controls each unit is composed of a CPU or a processor, a RAM (Random Access Memory), a ROM (Read Only Memory), and the like, and stored in the electric storage device 9003 in this example. The control device 9010 connected to the electric storage device 9003, the home power generation device 9004, the power consumption device 9005, the various sensors 9011, the server 9013 via the information network 9012, has the function of regulating, for example, the commercial power usage and the power generation. Further, the device may have a function such as handling a power trade in the power market.

As described above, the electric storage device 9003 can store therein electric power generated by not only the centralized power system 9002 such as the thermal power 9002a, the nuclear power 9002b, and the hydraulic power 9002c, but also the home power generation device 9004 (solar power generation, wind power generation).

Therefore, even if the home power generation device 9004 fluctuates in generated power, it is possible to achieve control such as making the amount of power sent to the outside constant or discharging the power as needed. For example, the system can be also used such that electric power obtained by solar power generation is stored in the electric storage device 9003, and at night, night-time power at a lower rate is stored in the electric storage device 9003, and then, the power stored by the electric storage device 9003 is discharged and used in the daytime at a higher rate.

It should be understood that while an example of the control device 9010 stored in the electric storage device 9003 has been described in this example, the control device 9010 may be stored in the smart meter 9007, or may be configured alone. Furthermore, the electric storage system 9100 may be used for multiple homes in multiple dwelling houses, or may be used for multiple detached houses.

A power tool according to the sixth embodiment of the present technology is a power tool including a battery pack according to the present technology and a movable part that is supplied with electric power from the battery pack. The power tool according to the sixth embodiment of the present technology includes the battery pack according to the present technology, which has excellent battery characteristics and excellent reliability, thus leading to an improvement in power tool performance.

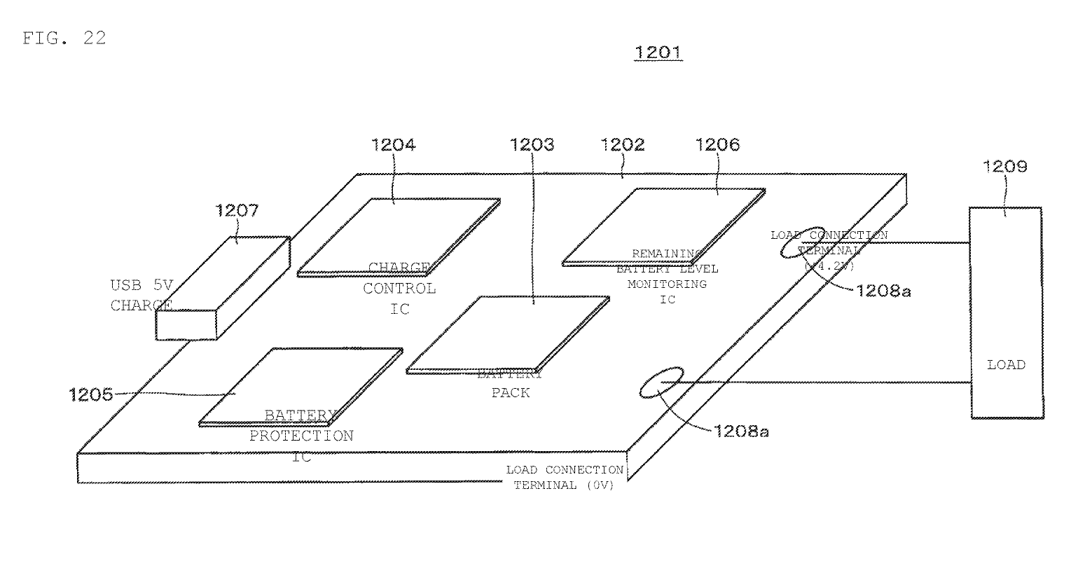

A power tool according to the sixth embodiment of the present technology will be described below with reference to FIG. 20.

FIG. 20 shows a block configuration of a power tool. This power tool is, for example, an electric drill, which includes a control unit 99 and a power supply 100 inside a tool body 98 formed from a plastic material or the like. For example, a drill part 101 as a movable part is operatably (rotatably) attached to the tool body 98.

The control unit 99 intended to control the operation (including the usage state of the power supply 100) of the whole power tool, includes, for example, a CPU and the like. The power supply 100 includes the battery pack (not shown) according to the technique described above. This control unit 99 is adapted to supply electric power from the power supply 100 to the drill part 101 in response to an operation of an operation switch, not shown.

An electronic device according to the seventh embodiment of the present technology is an electronic device including the battery pack according to the present technology, where the electronic device receives power supply from the battery pack. As described above, the electronic device according to the seventh embodiment of the present technology is a device that performs various functions with the battery pack as a driving power supply (power supply source). The electronic device according to the seventh embodiment of the present technology includes the battery pack according to the present technology, which has excellent battery characteristics and excellent reliability, thus leading to improvements in electronic device performance and reliability.

An electronic device according to the seventh embodiment of the present technology will be described below with reference to FIG. 21.

An example of the configuration of the electronic device 400 according to the seventh embodiment of the present technology will be described. The electronic device 400 includes an electronic circuit 401 of an electronic device main body, and the battery pack 300. It should be understood that the battery pack according to the present technology can be applied to the battery pack 300. The battery pack 300 is electrically connected to the electronic circuit 401 via a positive electrode terminal 331a and a negative electrode terminal 331b. The electronic device 400 has, for example, a configuration that allows the user to attach/detach the battery pack 300. It should be understood that the configuration of the electronic device 400 is not limited thereto, and the battery pack 300 may be configured to be built in the electronic device 400 so that the user is not allowed to remove the battery pack 300 from the electronic device 400.

In the case of charging the battery pack 300, the positive electrode terminal 331a and negative electrode terminal 331b of the battery pack 300 are respectively connected to a positive electrode terminal and a negative electrode terminal of a charger (not shown). On the other hand, in the case of discharging the battery pack 300 (in the case of using the electronic device 400), the positive electrode terminal 331a and negative electrode terminal 331b of the battery pack 300 are respectively connected to a positive electrode terminal and a negative electrode terminal of the electronic circuit 401.

Examples of the electronic device 400 include, but are not limited to, notebook personal computers, tablet computers, mobile phones (for example, smartphones), personal digital assistants (PDA), imaging devices (for example, digital still cameras, digital video cameras, etc.), audio instruments (for example, portable audio players), game machines, cordless phone handsets, electronic books, electronic dictionaries, radios, headphones, navigation systems, memory cards, pacemakers, hearing aids, lighting devices, toys, medical devices, and robots. As a specific example, a head-mounted display and a band-type electronic device will be described. The head-mounted display is an electronic device including an image display device, a mounting device for mounting the image display device on the head of the observer, and an attachment member for attaching the image display device to the mounting device, with a battery pack according to the present technology as a power source for driving, and the band-type electronic device is an electronic device including a plurality of segments connected in the form of a band, a plurality of electronic components disposed in the plurality of segments, and a flexible circuit board that connects the plurality of electronic components in the plurality of segments, disposed in a serpentine shape in at least one of the segments, where, for example, battery packs according to the present technology are disposed as the electronic components in the segments.

The electronic circuit 401 includes, for example, a CPU, a peripheral logic unit, an interface unit, a storage unit, and the like, and controls the overall electronic device 400.

The battery pack 300 includes an assembled battery 301 and a charge/discharge circuit 302. The assembled battery 301 is configured to have a plurality of secondary batteries 301a connected in series and/or in parallel. The plurality of secondary batteries 301a are connected so as to arrange, for example, n batteries in parallel and m batteries in serial (n and m are positive integers). It should be understood that FIG. 6 shows therein an example where six secondary batteries 301a are connected so as to arrange two batteries in parallel and three batteries in series (2P3S).

In the case of charging, the charge/discharge circuit 302 controls charging the assembled battery 301. On the other hand, in the case of discharging (that is, in the case of using the electronic device 400), the charge/discharge circuit 302 controls discharging the electronic device 400.

As shown in FIG. 22, the above-described battery pack can be mounted together with a charging circuit and the like on a printed circuit board 1202 (Printed Circuit Board, hereinafter referred to as “PCB”). For example, a battery pack 1203 and electronic circuits such as a charging circuit can be mounted on the PCB 1202 in accordance with a reflow step. The battery pack 1203 and electronic circuits such as a charging circuit mounted on the PCB 1202 are referred to as a battery module 1201. The battery module 1201 is configured as a card type, as necessary, and can be configured as a portable card-type mobile battery.

In addition, a charge control IC (Integrated Circuit) 1204, a battery protection IC 1205, and a remaining battery level monitoring IC 1206 are formed on the PCB 1202. The battery protection IC 1205 controls the charging-discharging operation such that the charging voltage is not excessive at the time of charge and discharge, no overcurrent flows due to a load short circuit, and no overdischarge is caused.

A USB (Universal Serial Bus) interface 1207 is attached to the PCB 1202. The battery pack 1203 is charged with electric power supplied through the USB interface 1207. In this case, the charging operation is controlled by the charge control IC 1204. Furthermore, predetermined electric power (for example, at a voltage of 4.2 V) is supplied to a load 1209 from load connection terminals 1208a and 1208b attached to the PCB 1202. The remaining battery level of the battery pack 1203 is monitored by the remaining battery level monitoring IC 1206, such that a display (not shown) indicative of the remaining battery level can be recognized from the outside. It should be understood that the USB interface 1207 may be used for load connection.

Here are specific examples of the above-described load 1209.

A. Wearable devices (sports watches, clocks, hearing aids, etc.),
B. IoT terminals (sensor network terminals, etc.),
C. Amusement devices (portable game terminals, game controllers),
D. IC substrate embedded batteries (real-time clock ICs),
E. Energy harvesting devices (electric storage elements for power generation elements such as photovoltaic power generation, thermoelectric power generation, and vibration power generation).

Currently, many people carry multiple credit cards. However, there is a problem that as the number of credit cards is increased, the risk of loss, theft, and the like is increased. Therefore, cards referred to as universal credit cards, which have functions such as multiple credit cards and club cards aggregated as all-in-one cards, have been put to practical use. In the cards, information can be captured such as the numbers and expiration dates of various credit cards and club cards, for example, and thus, if one of the cards is put in a wallet or the like, the cards can be selected and used any time.

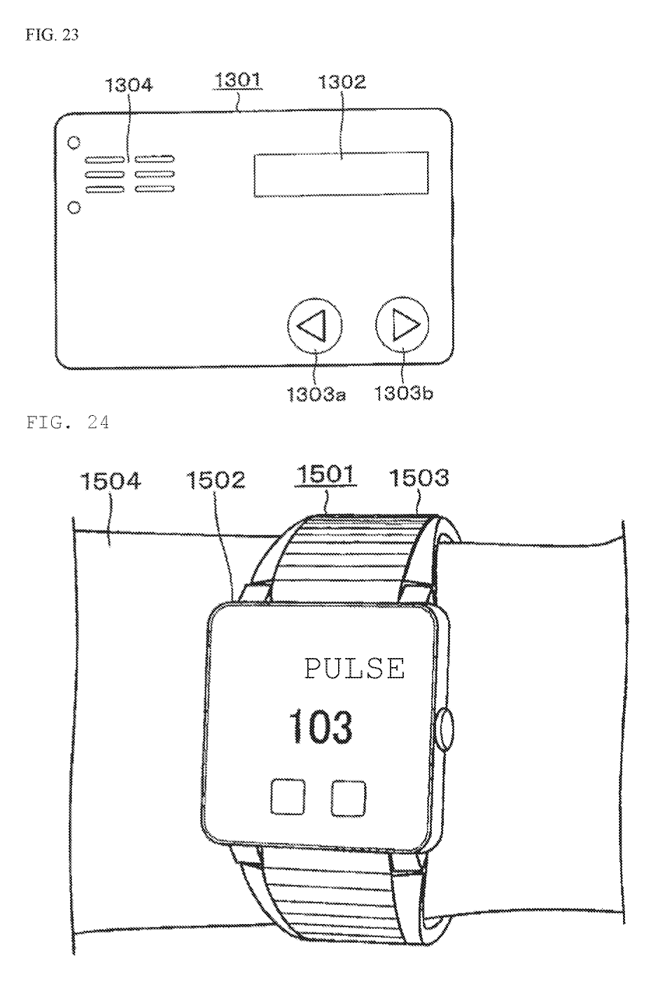

FIG. 23 shows an example of the configuration of a universal credit card 1301. The card has a card-type shape, in which an IC chip and battery pack (not shown) according to the present technology are embedded. Furthermore, a low power consumption display 1302 and operating parts, for example, direction keys 1303a and 1303b are provided. Furthermore, a charging terminal 1304 is provided on the surface of the universal credit card 1301.

For example, the user can specify the credit card or the like loaded in advance in the universal credit card 1301 by operating the direction keys 1303a and 1303b while viewing the display 1302. In a case in which multiple credit cards are loaded in advance, information indicating each credit card is displayed on the display 1302, and the user can specify a desired credit card by operating the direction keys 1303a and 1303b. Thereafter, the card can be used as with conventional credit cards. It is be noted that the foregoing card is considered by way of an example, and obviously, the battery pack according to the present technology is applicable to any electronic card other than the universal credit card 1301.

Examples of the wearable terminal include wristband-type electronic devices. Among the devices, a wristband-type activity meter, also referred to as a smart band, is just wrapped around the arm, thereby making it possible to acquire data on human activities such as a step count, a travel distance, calorie consumption, an amount of sleep, and a heart rate. Furthermore, the acquired data can be managed by a smartphone. Furthermore, the meter can be also provided with a mail sending/receiving function, and for example, a wristband-type activity meter is used which has a notification feature of notifying the user of incoming mail by an LED (Light Emitting Diode) lamp and/or a vibration.

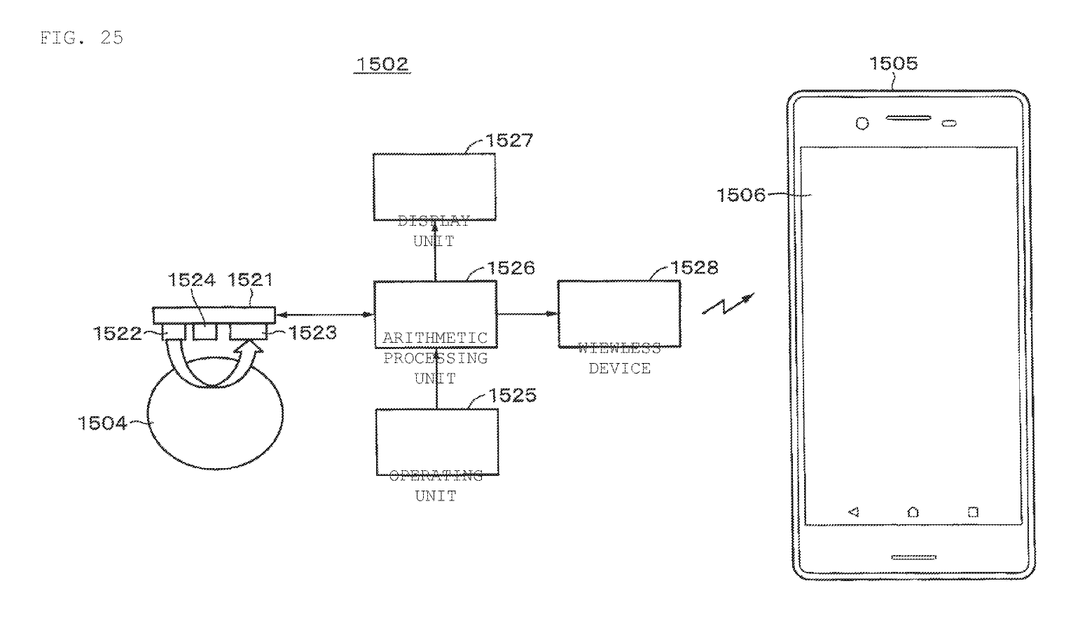

FIGS. 24 and 25 show an example of a wristband-type activity meter for measuring a pulse, for example. FIG. 9 shows a configuration example of the appearance of a wristband-type activity meter 1501. FIG. 25 shows a configuration example of a main body 1502 of the wristband-type activity meter 1501.

The wristband-type activity meter 1501 is a wristband-type measurement device for measuring, for example, a pulse of a subject by an optical method. As shown in FIG. 23, the wristband-type activity meter 1501 is composed of the main body 1502 and a band 1503, and like a wristwatch, a band 1503 is attached to an arm (wrist) 1504 of a subject. Then, the main body 1502 irradiates a part including the pulse of the arm 1504 of the subject with measurement light with a predetermined wavelength, and based on the intensity of the returned light, measures the pulse of the subject.

The main body 1502 is configured to include a substrate 1521, an LED 1522, a light-receiving IC 1523, a light-shielding body 1524, an operating unit 1525, an arithmetic processing unit 1526, a display unit 1527, and a wireless device 1528. The LED 1522, the light-receiving IC 1523, and the light-shielding body 1524 are provided on the substrate 1521. Under the control of the light-receiving IC 1523, the LED 1522 irradiates the part including the pulse of the arm 1504 of the subject with measurement light with a predetermined wavelength.

The light-receiving IC 1523 receives returned light after the arm 1504 is irradiated with the measurement light. The light-receiving IC 1523 generates a digital measurement signal indicating the intensity of the returned light, and supplies the generated measurement signal to the arithmetic processing unit 1526.

The light-shielding body 1524 is provided between the LED 1522 and the light-receiving IC 1523 on the substrate 1521. The light-shielding body 1524 prevents the measurement light from the LED 1522 from directly entering the light-receiving IC 1523.

The operating unit 1525 is composed of various types of operating members such as buttons and switches, for example, and provided on the surface of the main body 1502, or the like. The operating unit 1525 used for operating the wristband-type activity meter 1501, supplies a signal indicating the operation content to the arithmetic processing unit 1526.

The arithmetic processing unit 1526 performs arithmetic processing for measuring the pulse of the subject, based on the measurement signal supplied from the light-receiving IC 1523. The arithmetic processing unit 1526 supplies the result of the pulse measurement to the display unit 1527 and the wireless device 1528.

The display unit 1527 is composed of a display device such as an LCD (Liquid Crystal Display), for example, and provided on the surface of the main body 1502. The display unit 1527 displays the result of measuring the pulse of the subject, and the like.

The wireless device 1528 transmits the result of measuring the pulse of the subject to an external device by a predetermined method of radio communication. For example, as shown in FIG. 25, the wireless device 1528 transmits the result of measuring the pulse of the subject to a smartphone 1505, and displays the measurement result on a screen 1506 of the smartphone 1505. Furthermore, the data of the measurement result is managed by the smartphone 1505, thus allowing the measurement result to be viewed by the smartphone 1505 and stored in a server on the network. It should be understood that any method can be adopted for the communication method of the wireless device 1528. It should be understood that the light-receiving IC 1523 can also be used in the case of measuring a pulse at a part (for example, a finger, an earlobe, or the like) other than the arm 1504 of the subject.

The above-described wristband-type activity meter 1501 can accurately measure the pulse wave and pulse of the subject by removing the influence of body movements through signal processing in the light-receiving IC 1523. For example, even if the subject perform vigorous exercise such as running, the pulse wave and pulse of the subject can be accurately measured. In addition, for example, in a case in which the subject wears the wristband-type activity meter 1501 for a long period of time to perform a measurement, it is possible to continue to measure the pulse wave and the pulse accurately by removing the influence of body movements of the subject.

In addition, the power consumption of the wristband-type activity meter 1501 can be reduced by reducing the computation quantity. As a result, it becomes possible to perform the measurement with the wristband-type activity meter 1501 worn on the subject for a long period of time, without charging or replacing the battery, for example.

Further, as a power source, for example, a thin battery is housed in the band 1503. The wristband-type activity meter 1501 includes the electronic circuit in the main body and a battery pack. The meter has, for example, a configuration that allows the user to attach/detach the battery pack. The electronic circuit is the circuit included in the above-described main body 1502. The present technology can be applied in the case of using a battery pack.

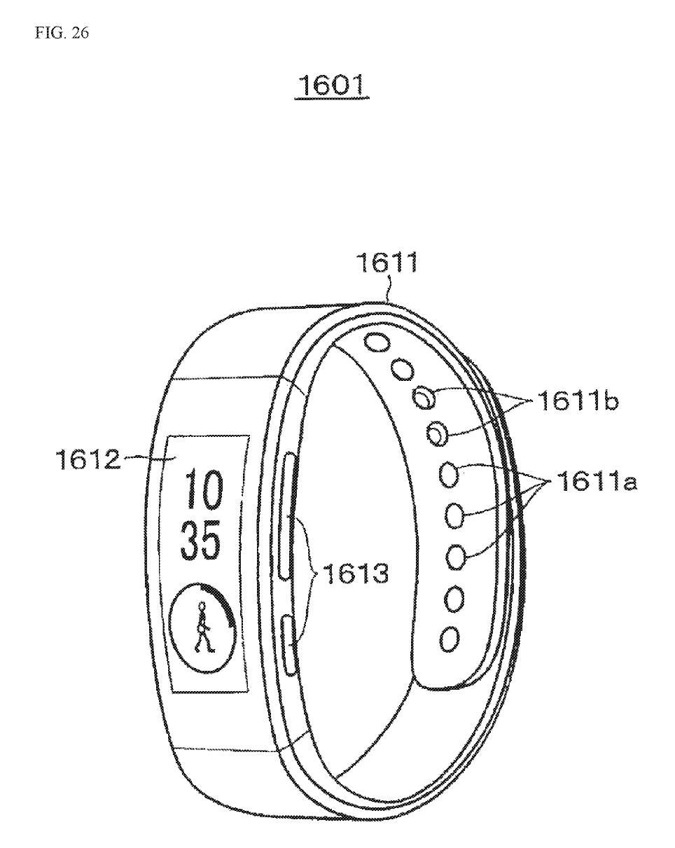

FIG. 26 shows therein a configuration example of the appearance of a wristband-type electronic device 1601 (hereinafter referred simply to as an “electronic device 1601”).

The electronic device 1601 is, for example, a so-called wearable device of a watch-type which is removable to and from a human body. The electronic device 1601 includes, for example, a band part 1611 that is worn on an arm, a display device 1612 that displays figures, words, patterns, and the like, and operation buttons 1613. The band part 1611 is formed with a plurality of holes 1611a and protrusions 1611b formed on the inner peripheral surface (the surface in contact with the arm in the case of mounting the electronic device 1601) side.

In use, the electronic device 1601 is bent such that the band part 1611 is substantially circular as shown in FIG. 26, and the protrusions 1611b are inserted into the holes 1611a, and then worn on the arm. Adjusting the positions of the holes 1611a into which the protrusions 1611b are inserted can adjust the magnitude of the diameter to correspond to the thickness of the arm. The electronic device 1601 is, out of in use, stored with the protrusions 1611b removed from the holes 1611a, and with the band part 1611 substantially flat. The sensor according to an embodiment of the present technology is provided over the entire band part 1611, for example.

A smartwatch has the same appearance as or a similar appearance to the design of an existing watch, which is worn for use on the user's arm like a watch, and has the function of informing the user of various types of messages such as incoming calls and e-mails through information displayed on a display. Furthermore, smartwatches have been also proposed which have functions such as an electronic money function and an activity meter. The smartwatch has a display incorporated in the surface of the main body part of the electronic device, and various types of information are displayed on the display. In addition, the smartwatch is also capable of, for example, via Near Field Communication such as Bluetooth (registered trademark) with a communication terminal (such as a smartphone), cooperating with the functions, contents, and the like of the communication terminal or the like.

As one of smartwatches, a smartwatch has been proposed which includes a plurality of segments connected in the form of a band, a plurality of electronic components disposed in the plurality of segments, and a flexible circuit board disposed in a serpentine shape in at least one of the segments, for connecting the plurality of electronic components in the plurality of segments. With such a serpentine shape, stress is not applied to the flexible circuit board even if the band is bent, thus preventing the circuit from being broken in. In addition, it is possible to build electronic circuit components in the band-side segments attached to the watch main body, rather than the housing constituting the watch main body, thereby eliminating the need to make a change to the watch main body side, and thus making it possible to constitute a smartwatch that has the same design as a conventional watch design. In addition, the smartwatch according to the present application example can provide notices such as e-mails and incoming calls, record logs such as a user's action history, and make calls and the like. In addition, the smartwatch has a function as a non-contact type IC card, and can make payments and conduct authentication and the like in a non-contact manner.

The smartwatch according to the present application example has, in a metallic band, built-in circuit components for performing communication processing and notification processing. In order to adapt the smartwatch to function as an electronic device, while reducing the thickness of the metallic band, the band is configured to have a plurality of segments connected, and a circuit board, a vibration motor, a battery, and an acceleration sensor are housed in each segment. Components such as the circuit board, vibration motors, battery, and acceleration sensor in each segment are connected by a flexible printed circuit board (FPC).

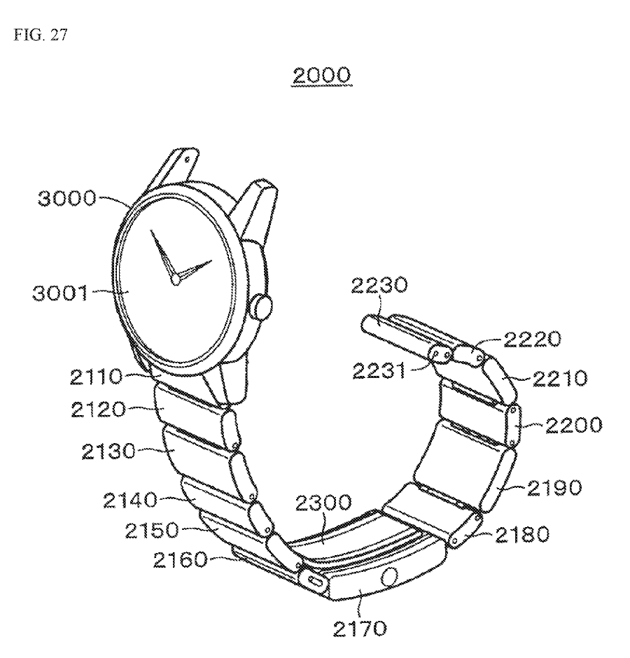

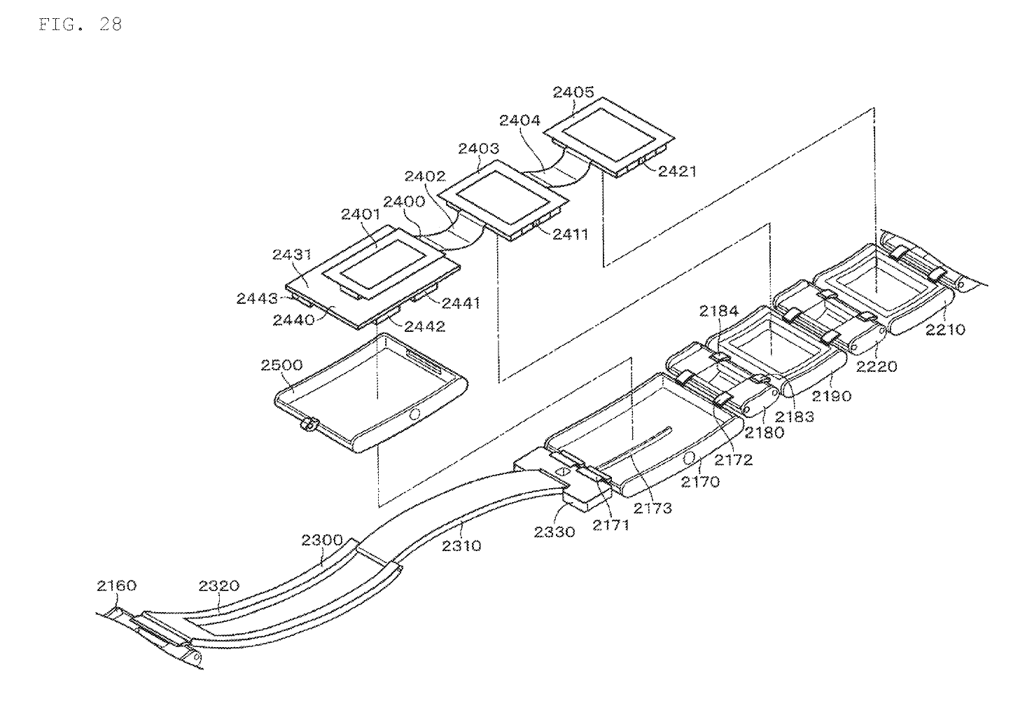

FIG. 27 shows the overall configuration (exploded perspective view) of a smartwatch. The band-type electronic device 2000 has a metallic band attached to a watch main body 3000, which is attached to the user's arm. The watch main body 3000 includes a dial face 3100 for displaying the time. The watch main body 3000 may electronically display the time on a liquid crystal display or the like, instead of the dial face 3100.

The band-type electronic device 2000 is configured to have a plurality of segments 2110 to 2230 connected. A segment 2110 is attached to one band attachment hole of the watch main body 3000, and a segment 2230 is attached to the other band attachment hole of the watch main body 3000. According to the present example, the respective segments 2110 to 2230 are made of a metal.

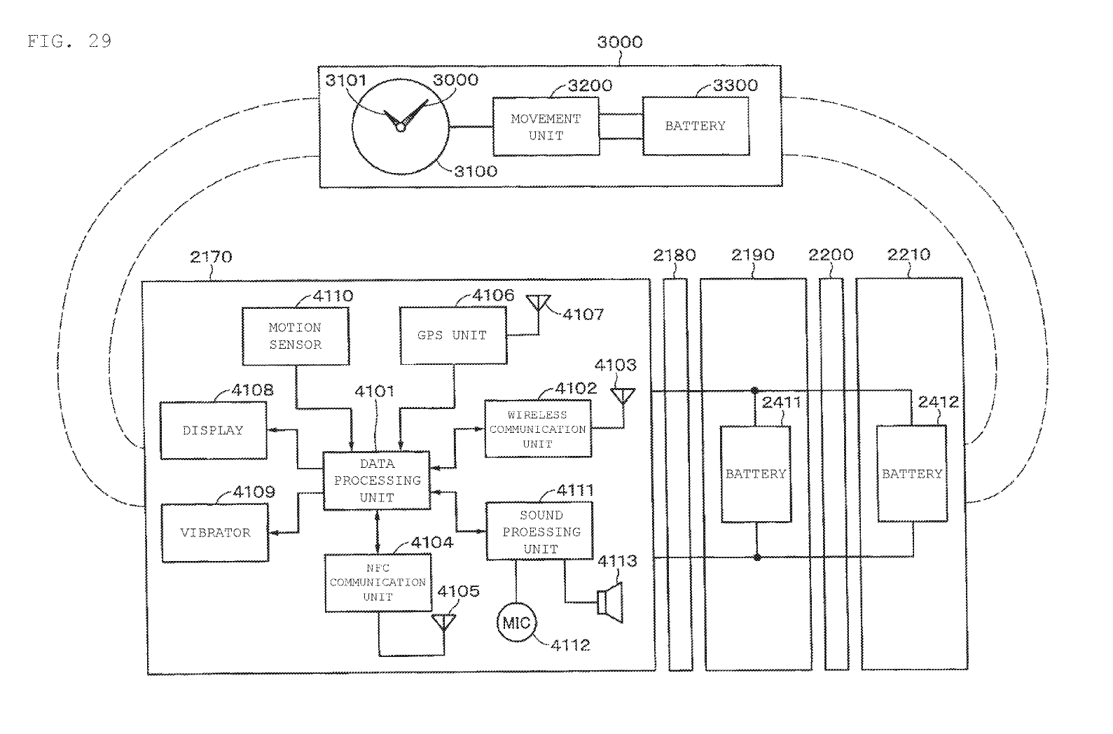

FIG. 28 shows a part of the inside configuration of the band-type electronic device 2000. For example, the inside of three segments 2170, 2180, 2190, 2200, and 2210 is shown. In the band-type electronic device 2000, a flexible circuit board 2400 is disposed in the five continuous segments 2170 to 2210. Various electronic components are disposed in the segment 2170, and batteries 2411, 2421 according to the present technology are disposed in the segments 2190, 2210, and these components are electrically connected by the flexible circuit board 2400. The segment 2180 between the segment 2170 and the segment 2190 has a relatively small size, where the serpentine flexible circuit board 2400 is disposed. Inside the segment 2180, the flexible circuit board 2400 is disposed to be sandwiched between waterproof members. It should be understood that the inside of the segments 2170 to 2210 has a waterproof structure.

FIG. 29 is a block diagram illustrating the circuit configuration of the band-type electronic device 2000. The circuitry inside the band-type electronic device 2000 is configured independently of the watch main body 3000. The watch main body 3000 includes a movement unit 3200 that rotates hands disposed on the dial face 3100. A battery 3300 is connected to the movement unit 3200. The movement unit 3200 and the battery 3300 are built in the housing of the watch main body 3000.

In the band-type electronic device 2000 connected to the watch main body 3000, electronic components are disposed in the three segments 2170, 2190, 2210. In the segment 2170, a data processing unit 4101, a wireless communication unit 4102, an NFC communication unit 4104, and a GPS unit 4106 are disposed. Antennas 4103, 4105, 4107 are connected respectively to the wireless communication unit 4102, the NFC communication unit 4104, and the GPS unit 4106. The respective antennas 4103, 4105, 4107 are disposed in the vicinity of a slit 2173 of the segment 2170, which will be described later.

The wireless communication unit 4102 performs Near Field Communication with another terminal in accordance with the standard of Bluetooth (registered trademark), for example. The NFC communication unit 4104 performs wireless communication with a close reader/writer in accordance with the standard of NFC. The GPS unit 4106 is a positioning unit that performs positioning of the actual position in response to receipt of a radio wave from a satellite of a system referred to as a GPS (Global Positioning System). The data obtained in the foregoing wireless communication unit 4102, NFC communication unit 4104, and GPS unit 4106 is supplied to the data processing unit 4101.

In addition, in the segment 2170, a display 4108, a vibrator 4109, a motion sensor 4110, and a sound processing unit 4111 are disposed. The display 4108 and the vibrator 4109 function as a notification unit for notifying the wearer of the band-type electronic device 2000. The display 4108 composed of a plurality of light emitting diodes notifies the user by turning on or blinking the light emitting diodes. The plurality of light emitting diodes is disposed inside the slit 2173, as will be described later, of the segment 2170, for example, and turned on or blinked for notification of incoming calls, e-mail reception, and the like. As the display 4108, a type that displays words, figures, and the like may be used. The vibrator 4109 is a member that vibrates the segment 2170. The band-type electronic device 2000 achieves notification of incoming calls, e-mail reception, and the like via the vibration of the segment 2170 by the vibrator 4109.

The motion sensor 4110 detects the movement of the user with the band-type electronic device 2000 worn. As the motion sensor 4110, an acceleration sensor, a gyroscope sensor, an electronic compass, an atmospheric pressure sensor, or the like is used. In addition, the segment 2170 may have built-in sensors other than the motion sensor 4110. For example, a biosensor may be built in which detects the pulse or the like of the user with the band-type electronic device 2000 worn. A microphone 4112 and a speaker 4113 are connected to the sound processing unit 4111, and the sound processing unit 4111 performs processing of a call with a party connected via wireless communication in the wireless communication unit 4102. In addition, the sound processing unit 4111 can also perform processing for sound input operation.

Further, the battery 2411 is built in the segment 2190, and the battery 2421 is built in the segment 2210. The batteries 2411 and 2421 can be composed of the battery pack according to the present technology, which supplies power for driving to the circuitry in the segment 2170. The circuitry in the segment 2170 and the batteries 2411 and 2421 are connected by the flexible circuit board 2400 (FIG. 28). It should be understood that although not shown in FIG. 29, the segment 2170 has terminals for charging the batteries 2411, 2421. In addition, electronic component other than the batteries 2411, 2421 may be disposed in the segments 2190, 2210. For example, the segments 2190, 2210 may be adapted to include a circuit that controls charging and discharging of the batteries 2411, 2421.

The eyewear-type terminal described below is intended to allow information such as texts, symbols, and images to be superimposed and displayed on the landscape in front of the eyes. More specifically, the terminal is equipped with a lightweight and thin image display device display module dedicated to the transmissive eyewear-type terminal. Typical examples of the terminal include a head-mounted display (head-mounted display (HMD)).

This image display device is composed of an optical engine and a hologram light guide plate. The optical engine emits image light such as images and texts with the use of a microdisplay lens. This image light enters the hologram light guide plate. The hologram light guide plate has a transparent plate with hologram optical elements incorporated at both ends of the transparent plate, and the image light from the optical engine is propagated through the transparent plate which is very thin such as 1 mm in thickness, and then delivered to the eyes of an observer. Such a configuration achieves a lens of 3 mm in thickness (including a protective plate around the light guide plate), which has a transmittance of 85%, for example. The eyewear-type terminal of interest makes it possible to see the results of players and teams in real time in the middle of watching sports, and display tour guides at travel destinations.

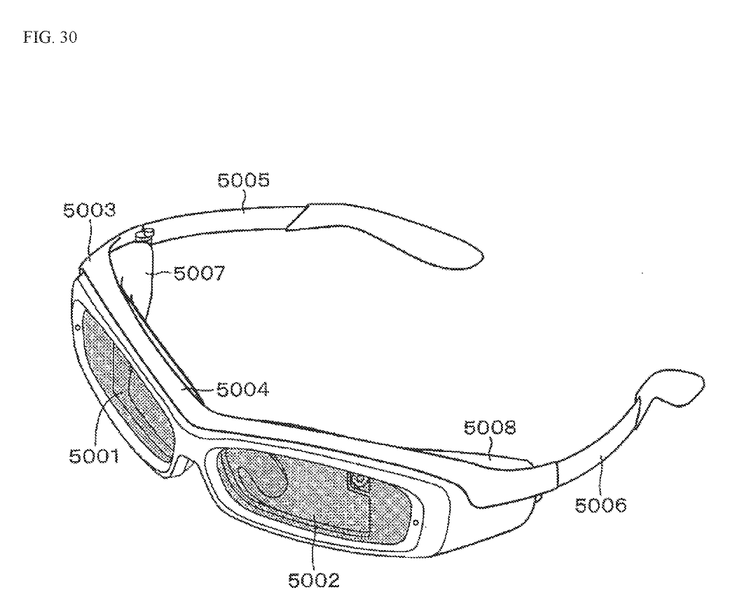

In a specific example of the eyewear-type terminal, as shown in FIG. 30, an image display unit has an eyewear-type configuration. More specifically, as with normal eyeglasses, the terminal has a frame 5003 for holding a right image display unit 5001 and a left image display unit 5002 in front of the eyes. The frame 5003 is composed of a front part 5004 disposed in front of the observer and two temple parts 5005, 5006 pivotally attached to both ends of the front part 5004 with hinges interposed therebetween. The frame 5003 is made of the same material as a material constituting normal glasses, such as a metal, an alloy, a plastic, and a combination thereof. It should be understood that a headphone part may be provided.

The right image display unit 5001 and the left image display unit 5002 are arranged so as to be located respectively in front of the right eye and left eye of the user. The temple parts 5005 and 5006 hold the image display units 5001 and 5002 on the user's head. At the connection between the front part 5004 and the temple part 5005, a right display driving unit 5007 is disposed inside the temple part 5005. At the connection between the front part 5004 and the temple part 5006, a left display driving unit 5008 is disposed inside the temple part 5006.

Although omitted in FIG. 30, the frame 5003 is equipped with a battery pack according to the present technology, an acceleration sensor, a gyro, an electronic compass, a microphone/speaker, and the like. Furthermore, an imaging device is attached, thereby allowing still images/moving images to be shot. Furthermore, the frame includes a controller connected to the eyewear part via, for example, a wireless or wired interface. The controller is provided with a touch sensor, various buttons, a speaker, a microphone, and the like. Furthermore, the frame has the function of cooperating with smartphones. For example, the GPS function of a smartphone is utilized, thereby making it possible to provide information depending on the user's situation.

The present technology is not to be considered limited to each of the respective embodiments and application examples mentioned above, and can be modified without departing from the scope of the present technology.

The present technology is described below in further detail according to an embodiment.

[1] A battery pack including at least a battery cell and a holder, where the battery cell is housed in the holder, the holder includes a plate-shaped member having a first placement surface on which the battery cell is placed and a first side member and a second side member extending substantially perpendicular to the first placement face and on the side on which the battery cell is placed, a length of the first side member and the second side member extending to the side on which the battery cell is mounted is larger than a length in a direction substantially perpendicular to the first mounting surface of the battery cell.
[2] The battery pack according to [1], including a substrate, where the substrate is housed in the holder, and the flat plate-shaped member has a second placement surface with the substrate placed thereon, on the back side of the first placement surface.
[3] The battery pack according to [2], including a connection tab, where the connection tab is configured to have a first connection connected to one electrode of the battery cell and a second connection connected to the other electrode of the battery cell, integrated by an insulating member.
[4] The battery pack according to [3], including a connection member connected to the connection tab and the substrate, where the connection member has a structure such that the connection member gradationally changes in length in a direction substantially perpendicular to the direction of the connections among the connection tab, the connection member, and the substrate.
[5] The battery pack according to any one of [1] to [4], where the battery cell is a laminate-type battery.
[6] The battery pack according to any one of [1] to [5], where the holder and the battery cell are fixed with an adhesive tape.
[7] A battery pack comprising at least a battery cell and a battery cell holder, where the battery cell is housed in the battery cell holder, the battery cell holder includes a plate-shaped member that has a first placement surface with the battery cell placed thereon, and a first side surface member and a second side surface member that are substantially perpendicular to the first placement surface and extend to the side with the battery cell placed, the first side surface member and the second side surface member are larger in length extending to the side with the battery cell placed than the battery cell in a direction substantially perpendicular to the first placement surface, the plate-shaped member further has a second placement surface with the battery cell placed, on the back side of the first placement surface, the battery cell holder includes a third side surface member and a fourth side surface member that are substantially perpendicular to the second placement surface and extend to the side with the battery cell placed, and the third side surface member and the fourth side surface member are larger in length extending to the side with the battery cell placed than the battery cell in a direction substantially perpendicular to the second placement surface.
[8] The battery pack according to [7], further including a substrate and a substrate holder, where the substrate is housed in the substrate holder, and the substrate holder includes a plate-shaped member with a placement surface with the substrate placed thereon.
[9] The battery pack according to [8], where the battery cell holder and the substrate holder are fixed in a direction substantially perpendicular to the plate-shaped member of the battery cell holder and the plate-shaped member of the substrate holder.
[10] The battery pack according to [8] or [9], including a connection tab, where the connection tab is configured to have a first connection connected to one electrode of the battery cell and a second connection connected to the other electrode of the battery cell, integrated by an insulating member.
[11] The battery pack according to [10], including a connection member connected to the connection tab and the substrate, where the connection member has a structure such that the connection member gradationally changes in length in a direction substantially perpendicular to the direction of the connections among the connection tab, the connection member, and the substrate.
[12] The battery pack according to any one of [7] to [11], where the battery cell is a laminate-type battery.
[13] The battery pack according to any one of [7] to [12], where the battery cell holder and the battery cell are fixed with an adhesive tape.
[14] A vehicle including: the battery pack according to any one of [1] to [13]; a driving force conversion device that receives power supply from the battery pack to convert the power to a driving force for the vehicle; a driving unit that works in accordance with the driving force; and a vehicle control device.
[15] An electric storage system including: a power storage device including the battery pack according to any one of [1] to [13]; a power consumption device that is supplied with electric power from the battery pack; a control device that controls power supply to the power consumption device from the battery pack; and a power generation device that charges the battery pack.
[16] A power tool including: the battery pack according to any one of [1] to [13]; and a movable part that is supplied with electric power from the battery pack.
[17] An electronic device including the battery pack according to any one of [1] to [13], where the electronic device receives power supply from the battery pack.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising at least a battery cell and a holder, wherein
the battery cell is configured to be accommodated in the holder,
the holder includes a plate-shaped member having a first placement surface with the battery cell placed thereon, and a first side surface member and a second side surface member that are substantially perpendicular to the first placement surface and extend to a side with the battery cell, and
the first side surface member and the second side surface member are larger in length extending to the side with the battery cell than the battery cell in a direction substantially perpendicular to the first placement surface.

2. The battery pack according to claim 1, comprising a substrate, wherein
the plate-shaped member has a second placement surface with the substrate placed thereon on an opposite side of the first placement surface.

3. The battery pack according to claim 2, comprising a connection tab, wherein
the connection tab is configured to have a first connection connected to a first electrode of the battery cell and a second connection connected to a second electrode of the battery cell, and the connection tab is integrated by an insulating member.

4. The battery pack according to claim 3, comprising a connection member connected to the connection tab and the substrate, wherein
the connecting member has a structure such that the connection member gradationally changes in length in a direction substantially perpendicular to a direction of connections among the connection tab, the connection member, and the substrate.

5. The battery pack according to claim 1, wherein the battery cell includes a laminate-type battery.

6. The battery pack according to claim 1, wherein the holder and the battery cell are fixed with an adhesive tape.

7. A battery pack comprising at least a battery cell and a battery cell holder, wherein
the battery cell is configured to be accommodated in the battery cell holder,
the battery cell holder includes a plate-shaped member having a first placement surface with the battery cell placed thereon, and a first side surface member and a second side surface member that are substantially perpendicular to the first placement surface and extend to a side with the battery cell,
the first side surface member and the second side surface member are larger in length extending to the side with the battery cell than the battery cell in a direction substantially perpendicular to the first placement surface, and the plate-shaped member further has a second placement surface with the battery cell placed on an opposite side of the first placement surface,
the battery cell holder includes a third side surface member and a fourth side surface member that are substantially perpendicular to the second placement surface and extend to the side with the battery cell, and
the third side surface member and the fourth side surface member are larger in length extending to the side with the battery cell than the battery cell in a direction substantially perpendicular to the second placement surface.

8. The battery pack according to claim 7, further comprising a substrate and a substrate holder, wherein
the substrate is configured to be accommodated in the substrate holder, and
the substrate holder includes a first plate-shaped member with a first placement surface with the substrate placed thereon.

9. The battery pack according to claim 8, wherein the battery cell holder and the substrate holder are fixed in a direction substantially perpendicular to the plate-shaped member of the battery cell holder and the first plate-shaped member of the substrate holder.

10. The battery pack according to claim 8, comprising a connection tab, wherein
the connection tab is configured to have a first connection connected to a first electrode of the battery cell and a second connection connected to a second electrode of the battery cell, and the connection tab is integrated by an insulating member.

11. The battery pack according to claim 10, comprising a connection member connected to the connection tab and the substrate, wherein
the connection member has a structure such that the connection member gradationally changes in length in a direction substantially perpendicular to a direction of connections among the connection tab, the connection member, and the substrate.

12. The battery pack according to claim 7, wherein the battery cell includes a laminate-type battery.

13. The battery pack according to claim 7, wherein the battery cell holder and the battery cell are fixed with an adhesive tape.

14. A vehicle comprising:
the battery pack according to claim 1;
a driving force converter configured to receive power supplied from the battery pack to convert the power to a driving force for the vehicle;
a driver configured to work in accordance with the driving force; and
a vehicle controller.

15. An electric storage system comprising:
a power storage device comprising the battery pack according to claim 1;
a power consumption device configured to be supplied with electric power from the battery pack;
a controller configured to control power supply to the power consumption device from the battery pack; and
a power generator configured to charge the battery pack.

16. A power tool comprising:
the battery pack according to claim 1; and
a movable part that is configured to be supplied with electric power from the battery pack.

17. An electronic device comprising the battery pack according to claim 1, wherein the electronic device is configured to receive power supply from the battery pack.

18. A vehicle comprising:
the battery pack according to claim 7;
a driving force converter configured to receive power supplied from the battery pack to convert the power to a driving force for the vehicle;
a driver configured to work in accordance with the driving force; and
a vehicle controller.

19. An electric storage system comprising:
a power storage device comprising the battery pack according to claim 7;
a power consumption device that is configured to be supplied with electric power from the battery pack;
a controller configured to control power supply to the power consumption device from the battery pack; and
a power generator configured to charge the battery pack.

20. An electronic device comprising the battery pack according to claim 7, wherein
the electronic device is configured to receive power supply from the battery pack.
